(19) United States
(12) Patent Application Publication
(10) Pub. No.: US 2024/0414382 A1
(43) Pub. Date: Dec. 12, 2024

(54) METHOD FOR DISPLAYING LIVE STREAMING DATA, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Shangsheng LI, Beijing (CN); Pu ZHENG, Beijing (CN)

(21) Appl. No.: 18/526,858

(22) Filed: Dec. 1, 2023

(30) Foreign Application Priority Data
Jun. 12, 2023 (CN) 202310690669.7

(51) Int. Cl. H04N 21/2187; H04N 21/258

(52) U.S. Cl. CPC H04N 21/2187; H04N 21/25825

(57) ABSTRACT

A method for displaying live streaming data includes: acquiring, during an interactive live streaming, live streaming data streams of a first user account and at least one second user account participating in the interactive live streaming; acquiring a screen ratio corresponding to each of the first user account and the second user account, wherein the screen ratio corresponding to the first user account is determined according to an interaction value of the first user account and the screen ratio corresponding to the second user account is determined according to an interaction value of the second user account; and displaying, based on the acquired screen ratio, live streaming pictures of the first user account and the second user account on a live streaming interface of the first user account based on the live streaming data streams.

The present disclosure claims priority to Chinese Patent Application No. 202310690669.7 filed on Jun. 12, 2023 and entitled “METHOD AND APPARATUS FOR DISPLAYING LIVE STREAMING DATA, ELECTRONIC DEVICE, AND STORAGE MEDIUM”, the content of which is incorporated herein by reference in its entirety.

### TECHNICAL FIELD

The present disclosure relates to the field of the Internet technologies, in particular, relates to a method for displaying live streaming data, an electronic device, and a storage medium.

### BACKGROUND

With the rapid development of Internet technology, applications with live streaming capabilities (such as a short video application) becomes more popular. The manners of live streaming also become more diversified, for example, a new way of live streaming called interactive live streaming is currently receiving widespread attention from users.

An interactive live streaming is conducted by a plurality of anchor users streaming together. During the interactive live streaming, participating anchor users can initiate interactive battle (PK) activities. Taking two anchor users as an example, during the PK process, the live streaming pictures from the two anchor users are displayed in a split-screen form with each live streaming picture occupying half of the screen, allowing the audience users to see both live streaming pictures on the screen.

### SUMMARY

The present disclosure provides a method for displaying live streaming data, an electronic device, and a storage medium. Technical solutions of the present disclosure are as follows.

According to an aspect of embodiments of the present disclosure, a method for displaying live streaming data is provided. The method is applicable to a terminal and includes:
acquiring, during an interactive live streaming, live streaming data streams of a first user account and at least one second user account participating in the interactive live streaming;
acquiring a screen ratio corresponding to each of the first user account and the second user account, wherein the screen ratio corresponding to the first user account is determined according to an interaction value of the first user account and the screen ratio corresponding to the second user account is determined according to an interaction value of the second user account; and
displaying, based on the acquired screen ratio, live streaming pictures of the first user account and the second user account on a live streaming interface of the first user account based on the live streaming data streams.

In some embodiments, displaying, based on the acquired screen ratio, the live streaming pictures of the first user account and the second user account on the live streaming interface of the first user account based on the live streaming data streams includes:
determining, under a current split-screen mode, a display area corresponding to each of the first user account and the second user account on the live streaming interface based on the acquired screen ratio; and
displaying, in the determined display area, the live streaming picture of each of the first user account and the second user account based on the live streaming data streams.

In some embodiments, displaying, in the determined display area, the live streaming picture of each of the first user account and the second user account based on the live streaming data streams includes:
displaying, in a case that a display area corresponding to the first user account is larger than a display area corresponding to the second user account, a live streaming picture of the first user account in the display area corresponding to the first user account based on a live streaming data stream of the first user account; and
displaying, based on a live streaming data stream of the second user account, a live streaming picture of the second user account in a first display area and a virtual resource in a second display area,
wherein the display area corresponding to the second user account includes the first display area and the second display area; a difference between the interaction value of the first user account and the interaction value of the second user account is inversely proportional to a size of the first display area and directly proportional to a size of the second display area.

In some embodiments, during the interactive live streaming, the method further includes:
canceling, in response to the size of the first display area being smaller than a first threshold, a display of the live streaming picture of the second user account, and displaying, in a display form of not being covered by the virtual resource, identification information of the second user account in the display area corresponding to the second user account.

In some embodiments, the virtual resource is a virtual effect or a preset background image.

In some embodiments, displaying, in the determined display area, the live streaming picture of each of the first user account and the second user account based on the live streaming data streams includes:
displaying, in a case that a display area corresponding to the first user account is larger than a display area corresponding to the second user account, a live streaming picture of the first user account in the display area corresponding to the first user account and a live streaming picture of the second user account in the display area corresponding to the second user account in a display form of covering the live streaming picture of the second user account with the live streaming picture of the first user account based on the live streaming data streams,
wherein a difference between an interaction value of the first user account and an interaction value of the second user account is directly proportional to a coverage range of the live streaming picture of the first user account over the live streaming picture of the second user account.

In some embodiments, during the interactive live streaming, the method further includes:
canceling, in response to the coverage range of the live streaming picture of the first user account over the live streaming picture of the second user account being greater than a second threshold, a display of the live streaming picture of the second user account, and displaying, in a display form of not being covered by the live streaming picture of the first user account, identification information of the second user account in the display area corresponding to the second user account.

In some embodiments, during the interactive live streaming, the method further includes:
displaying, in response to receiving a feedback instruction, the live streaming picture of each of the first user account and the second user account on the live streaming interface in a screen ratio corresponding to a current split-screen mode based on the acquired live streaming data streams,
wherein the feedback instruction is generated based on a trigger operation by either the first user account or the second user account on a target control, the target control being configured to cancel a display of live streaming pictures according to screen ratios determined by interaction values.

In some embodiments, acquiring the screen ratio corresponding to each of the first user account and the second user account includes:
acquiring, in a case that a preset condition is met, the screen ratio corresponding to each of the first user account and the second user account,
wherein the preset condition includes at least one of:
a version number of a target application installed on a first terminal and a second terminal being greater than a preset version number, wherein the first terminal is a terminal corresponding to the first user account and the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of an initiator in the interactive live streaming between the first user account and the second user account being greater than a threshold number; and
both the interaction value of the first user account and the interaction value of the second user account being greater than a score threshold.

In some embodiments, acquiring the screen ratio corresponding to each of the first user account and the second user account includes:
acquiring, in a case that a preset function from the target application is enabled, the screen ratio corresponding to each of the first user account and the second user account,
wherein the preset function is configured to enable displaying the live streaming pictures according to screen ratios determined by interaction values.

In some embodiments, acquiring the screen ratio of each of the first user account and the second user account includes:
acquiring a current interaction value of each of the first user account and the second user account;
acquiring a screen ratio sent in a last time;
determining, based on the current interaction value of each of the first user account and the second user account, an initial screen ratio;
determining, in a case that a difference between the initial screen ratio and the screen ratio sent in the last time is greater than a set threshold, a new screen ratio according to the screen ratio sent in the last time and a preset variation step size; and determining the new screen ratio as a screen ratio to be sent currently.

In some embodiments, determining, based on the current interaction value of each of the first user account and the second user account, the initial screen ratio includes:
determining, based on the current interaction value of each of the first user account and the second user account, a current interaction value ratio between the first user account and the second user account;
acquiring a mapping relationship between an interaction value ratio and a screen ratio, wherein the mapping relationship includes a plurality of screen ratio levels;
determining a screen ratio level corresponding to the current interaction value ratio based on the mapping relationship; and
determining, based on the screen ratio level, the initial screen ratio.

In some embodiments, during the interactive live streaming, the method further includes:
displaying, according to the interaction value of the first user account and the interaction value of the second user account, a progress display control based on a size of the live streaming interface,
wherein a length of the progress display control is a same as a width or height of the live streaming interface, and the progress display control displays a progress bar corresponding to each of the first user account and the second user account, and a length of each progress bar being determined based on an interaction value of a corresponding user account.

In some embodiments, in response to a difference in the progress bar lengths between the first user account and the second user account falling within a first interval, a display area boundary between the first user account and the second user account aligns with a progress bar boundary.

In some embodiments, in response to a difference in the progress bar lengths between the first user account and the second user account falling within a second interval, a display area boundary between the first user account and the second user account is staggered with a progress bar boundary, wherein left boundary value of the second interval is smaller than left boundary value of a first interval, and right boundary value of the second interval is smaller than right boundary value of the first interval;
the difference in the progress bar lengths between the first user account and the second user account is directly proportional to a degree of staggering between the display area boundary and the progress bar boundary.

According to another aspect of the embodiments of the present disclosure, a method for displaying live streaming data is provided. The method is applicable to a server and includes:
sending, during an interactive live streaming, a live streaming data stream of at least one second user account participating in the interactive live streaming to a first terminal corresponding to a first user account;
determining, according to an interaction value of each of the first user account and the second user account, a screen ratio corresponding to each of the first user account and the second user account; and
sending the screen ratio corresponding to each of the first user account and the second user account to the first terminal,
wherein the first terminal is configured to display, based on the acquired screen ratio, live streaming pictures of the first user account and the second user account on a live streaming interface of the first user account based on live streaming data streams of the first user account and the second user account.

In some embodiments, determining, according to the interaction value of each of the first user account and the second user account, the screen ratio corresponding to each of the first user account and the second user account includes:
acquiring a current interaction value of each of the first user account and the second user account;
acquiring a screen ratio sent in a last time; and
determining, based on the current interaction value of each of the first user account and the second user account and the screen ratio sent in the last time, a screen ratio to be sent currently;
and sending the screen ratio corresponding to each of the first user account and the second user account to the first terminal includes:
determining, in response to a difference between the screen ratio to be sent currently and the screen ratio sent in the last time, the screen ratio to be sent currently as a new screen ratio corresponding to each of the first user account and the second user account and sending the new screen ratio to the first terminal.

In some embodiments, determining, according to the interaction value of each of the first user account and the second user account, the screen ratio corresponding to each of the first user account and the second user account includes:
determining, in response to meeting a preset condition, the screen ratio corresponding to each of the first user account and the second user account according to the interaction value of each of the first user account and the second user account,
wherein the preset condition includes at least one of:
a version number of a target application installed on the first terminal and a second terminal being greater than a preset version number, wherein the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of an initiator in the interactive live streaming between the first user account and the second user account being greater than a threshold number; and
both the interaction value of the first user account and the interaction value of the second user account being greater than a score threshold.

In some embodiments, sending the screen ratio corresponding to each of the first user account and the second user account to the first terminal includes:
acquiring a change event during the interactive live streaming, wherein the change event is configured to change a current live streaming picture layout;
acquiring, in a case that there are a plurality of change events, a candidate change event by sorting the plurality of change events, and categorizing by priority and filtering the sorted change events; and
sending, in response to a current pending candidate change event configured to indicate displaying the live streaming pictures according to a screen ratio, the screen ratio of each of the first user account and the second user account to the first terminal.

In some embodiments, acquiring the candidate change event by sorting the plurality of change events, and categorizing by priority and filtering the sorted change events includes:
acquiring the sorted change events by sorting the plurality of change events in chronological order; and
acquiring the candidate change event by categorizing the sorted change events by priority according to business types thereof and filtering out duplicate filterable change events,
wherein the filterable change events include events related to displaying the live streaming pictures according to a screen ratio.

In some embodiments, during the interactive live streaming, the method further includes:
acquiring a number of likes and a quantity of virtual resources gifted by a third user account to the first user account;
acquiring a number of likes and a quantity of virtual resources gifted by the third user account to the second user account;
determining, based on at least one of the number of likes and the number of virtual resources corresponding to the first user account, the interaction value of the first user account; and
determining, based on at least one of the number of likes and the number of virtual resources corresponding to the second user account, the interaction value of the first user account.

According to another aspect of the embodiments of the present disclosure, an electronic device is provided. The electronic device includes:
one or more processors; and
a memory, configured to store one or more program codes executable by the one or more processors,
wherein the one or more processors, when loading and executing the one or more program codes, are caused to perform:
acquiring, during an interactive live streaming, live streaming data streams of a first user account and at least one second user account participating in the interactive live streaming;
acquiring a screen ratio corresponding to each of the first user account and the second user account, wherein the screen ratio is determined according to interaction values between the first user account and the second user account; and
displaying, based on the acquired screen ratio, live streaming pictures of the first user account and the second user account on a live streaming interface of the first user account based on the live streaming data streams.

According to another aspect of the embodiments of the present disclosure, a computer-readable storage medium storing at least one program code is provided. The at least one program code, when executed by a processor of an electronic device, causes the electronic device to perform:
acquiring, during an interactive live streaming, live streaming data streams of a first user account and at least one second user account participating in the interactive live streaming;
acquiring a screen ratio corresponding to each of the first user account and the second user account, wherein the screen ratio corresponding to the first user account is determined according to an interaction value of the first user account and the screen ratio corresponding to the second user account is determined according to an interaction value of the second user account; and
displaying, based on the acquired screen ratio, live streaming pictures of the first user account and the second user account on a live streaming interface of the first user account based on the live streaming data streams.

According to another aspect of the embodiments of the present disclosure, a computer program product is provided. The computer program product includes at least one computer program. The at least one computer program, when executed by a processor, causes the processor to perform:
acquiring, during an interactive live streaming, live streaming data streams of a first user account and at least one second user account participating in the interactive live streaming;
acquiring a screen ratio corresponding to each of the first user account and the second user account, wherein the screen ratio corresponding to the first user account is determined according to an interaction value of the first user account and the screen ratio corresponding to the second user account is determined according to an interaction value of the second user account; and
displaying, based on the acquired screen ratio, live streaming pictures of the first user account and the second user account on a live streaming interface of the first user account based on the live streaming data streams.

According to another aspect of the embodiments of the present disclosure, an electronic device is provided. The electronic device includes:
one or more processors; and
a memory, configured to store one or more program codes executable by the one or more processors,
wherein the one or more processors, when loading and executing the one or more program codes, are caused to perform:
sending, during an interactive live streaming, a live streaming data stream of at least one second user account participating in the interactive live streaming to a first terminal corresponding to a first user account;
determining, according to an interaction value of each of the first user account and the second user account, a screen ratio corresponding to each of the first user account and the second user account; and
sending the screen ratio corresponding to each of the first user account and the second user account to the first terminal,
wherein the first terminal is configured to display, based on the acquired screen ratio, live streaming pictures of the first user account and the second user account on a live streaming interface of the first user account based on live streaming data streams of the first user account and the second user account.

According to another aspect of the embodiments of the present disclosure, a computer-readable storage medium storing program codes is provided. The program codes, when executed by a processor of an electronic device, cause the electronic device to perform:
sending, during an interactive live streaming, a live streaming data stream of at least one second user account participating in the interactive live streaming to a first terminal corresponding to a first user account;
determining, according to an interaction value of each of the first user account and the second user account, a screen ratio corresponding to each of the first user account and the second user account; and
sending the screen ratio corresponding to each of the first user account and the second user account to the first terminal,
wherein the first terminal is configured to display, based on the acquired screen ratio, live streaming pictures of the first user account and the second user account on a live streaming interface of the first user account based on live streaming data streams of the first user account and the second user account.

According to another aspect of the embodiments of the present disclosure, a computer program product is provided. The computer program product includes at least one computer program. The at least one computer program, when executed by a processor, causes the processor to perform:
sending, during an interactive live streaming, a live streaming data stream of at least one second user account participating in the interactive live streaming to a first terminal corresponding to a first user account;
determining, according to an interaction value of each of the first user account and the second user account, a screen ratio corresponding to each of the first user account and the second user account; and
sending the screen ratio corresponding to each of the first user account and the second user account to the first terminal,
wherein the first terminal is configured to display, based on the acquired screen ratio, live streaming pictures of the first user account and the second user account on a live streaming interface of the first user account based on live streaming data streams of the first user account and the second user account.

It should be understood that both the foregoing general description and the following detailed description are exemplary and explanatory only and are not construed as limiting the present disclosure.

### BRIEF DESCRIPTION OF THE DRAWINGS

The accompanying drawings herein, which are incorporated into and constitute a part of the specification, illustrate embodiments consistent with the present disclosure and, together with the description, serve to explain the principles of the present disclosure and are not construed as a limitation of the present disclosure.

FIG. 1 is a schematic diagram showing an implementation environment of a method for displaying live streaming data according to some embodiments of the present disclosure;

FIG. 2 is a flowchart showing a method for displaying live streaming data according to some embodiments of the present disclosure;

FIG. 3 is a flowchart showing another method for displaying live streaming data according to some embodiments of the present disclosure;

FIG. 4 is a flowchart showing still another method for displaying live streaming data according to some embodiments of the present disclosure;

FIG. 5 is an architectural schematic diagram showing a scheme for displaying live streaming data according to some embodiments of the present disclosure;

FIG. 6 is a flowchart showing a first scheme for displaying live streaming data according to some embodiments of the present disclosure;

FIG. 7 is a flowchart showing a second scheme for displaying live streaming data according to some embodiments of the present disclosure;

FIG. 8 is a flowchart showing a third scheme for displaying live streaming data according to some embodiments of the present disclosure;

FIG. 9 is a flowchart showing a fourth scheme for displaying live streaming data according to some embodiments of the present disclosure;

FIG. 10 is a schematic diagram showing a first live streaming interface according to some embodiments of the present disclosure;

FIG. 11 is a schematic diagram showing a second live streaming interface according to some embodiments of the present disclosure;

FIG. 12 is a schematic diagram showing a third live streaming interface according to some embodiments of the present disclosure;

FIG. 13 is a schematic diagram showing a fourth live streaming interface according to some embodiments of the present disclosure;

FIG. 14 is a schematic diagram showing a fifth live streaming interface according to some embodiments of the present disclosure;

FIG. 15 is a schematic diagram showing a sixth live streaming interface according to some embodiments of the present disclosure;

FIG. 16 is a flowchart showing a fifth scheme for displaying live streaming data according to some embodiments of the present disclosure;

FIG. 17 is a block diagram showing an apparatus for displaying live streaming data according to some embodiments of the present disclosure;

FIG. 18 is a block diagram showing another apparatus for displaying live streaming data according to some embodiments of the present disclosure;

FIG. 19 is a block diagram showing a terminal 1900 according to some embodiments of the present disclosure; and

FIG. 20 is a block diagram showing a server 2000 according to some embodiments of the present disclosure.

### DETAILED DESCRIPTION

To enable a person of ordinary skill in the art to better understand the technical solutions of the present disclosure, the technical solutions in embodiments of the present disclosure will be clearly and completely described below with reference to the accompanying drawings.

It should be noted that the terms “first,” “second”, and the like in the specification and claims of the present disclosure and the above accompanying drawings are used to distinguish similar objects, and do not have to be used to describe a specific order or sequence. It should be understood that the data is interchangeable under appropriate circumstances, such that the embodiments of the present disclosure described herein are capable of implementation in other sequences than those illustrated or described herein. The embodiments described in the following exemplary embodiments do not represent all embodiments consistent with the present disclosure. In turn, they are merely examples of apparatus and methods consistent with certain aspects of the present disclosure, as detailed in the appended claims.

The information (including but not limited to user device information, user personal information, and the like), data (including but not limited to data for analysis, stored data, displayed data, and the like), and signals involved in the present disclosure are obtained with user consent or obtained through proper authorization from all parties involved. The collection, use, and processing of relevant data must comply with the applicable laws, regulations, and standards of the relevant countries and regions.

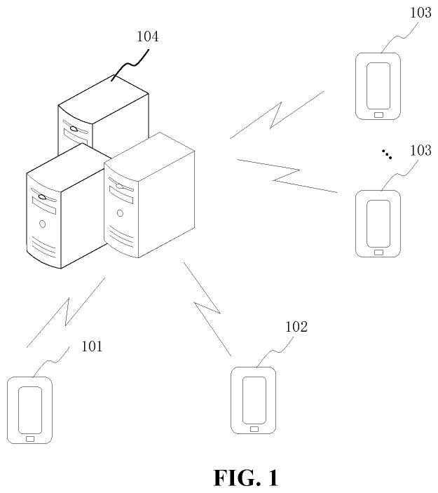

FIG. 1 is a schematic diagram showing an implementation environment of a method for displaying live streaming data according to some embodiments of the present disclosure.

Referring to FIG. 1, the implementation environment includes a first terminal 101, a second terminal 102, a third terminal 103, and a server 104. The first terminal 101, the second terminal 102, and the third terminal 103 have the target application installed. In some embodiments, the target application is an instant messaging application with live streaming capabilities, such as a short video application.

In some embodiments, the first terminal 101, the second terminal 102, and the third terminal 103 are electronic devices such as smartphones. In addition, a person skilled in the art may understand that the number of the above terminals may be more or less. For example, the above terminals may be only a few, dozens or hundreds, or even more, and the embodiments of the present disclosure do not limit either on the quantity or the type of terminals.

In some embodiments, the server 104 provides backend services for the target application. In addition, the server 104 is connected to the first terminal 101, the second terminal 102, and the third terminal 103 via wireless or wired networks. In addition, the servers involved in the embodiments of the present disclosure may further include other functional servers to provide more comprehensive and diversified services.

In the embodiments of the present disclosure, the first user account engages in interactive live streaming with the second user account via the first terminal 101. The first terminal 101 acquires the live streaming data of the first user account via a camera assembly, then sends the live streaming data of the first user account to the server 104, and receives live streaming data of the second user account from the server 104. Based on the acquired live streaming data of the first user account and the received live streaming data of the second user account, the first terminal 101 displays the live streaming pictures of the first user account and the second user account on the live streaming interface of the first user account. In some embodiments, the camera assembly is integrated into or connected externally to the first terminal 101, which is not limited in the present disclosure.

Similarly, the second user account engages in interactive live streaming with the first user account via the second terminal 102. The second terminal 102 acquires the live streaming data of the second user account via a camera assembly, then sends the live streaming data of the second user account to the server 104, and receives live streaming data of the first user account from the server 104. Based on the acquired live streaming data of the second user account and the received live streaming data of the first user account, the second terminal 102 displays the live streaming pictures of the first user account and the second user account on the live streaming interface of the second user account. In some embodiments, the camera assembly is integrated into or connected externally to the second terminal 102, which is not limited in the present disclosure.

In addition, the third user account, via the third terminal 103, receives the live streaming data of the first user account and the second user account sent by the server 104 and displays the live streaming picture of the first user account and the live streaming picture of the second user account. In other words, the first user account and the second user account interact as anchor accounts during the live streaming, while the third user account acts as an audience account, watching the interactive live streaming.

A detailed description of a method for displaying live streaming data provided by embodiments of the present disclosure is provided through the following embodiments.

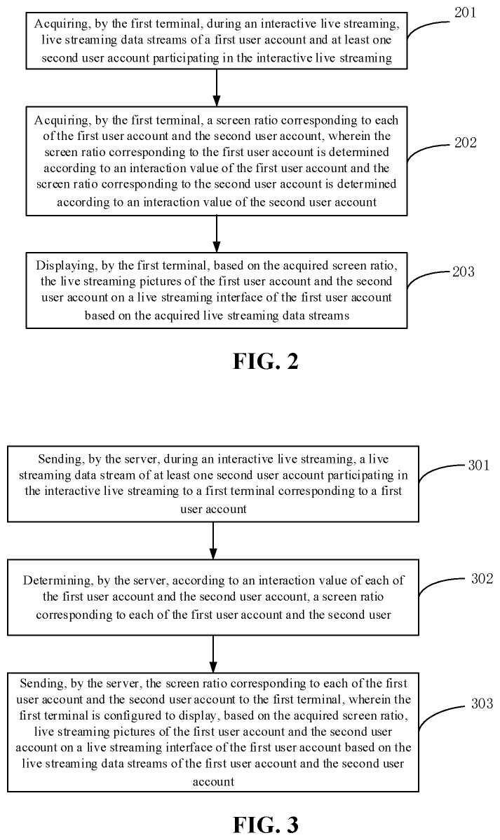

FIG. 2 is a flowchart showing a method for displaying live streaming data according to some embodiments of the present disclosure. As shown in FIG. 2, the method for displaying live streaming data is applied to an electronic device, such as the first terminal shown in FIG. 1. The method for displaying live streaming data includes the following processes.

In 201, the first terminal, during an interactive live streaming, acquires live streaming data streams of a first user account and at least one second user account participating in the interactive live streaming.

The interactive live streaming is conducted by a plurality of anchor users streaming together. During the interactive live streaming, the plurality of participating anchor accounts can initiate interactive PK activities. In addition, during the interactive live streaming, the terminal corresponding to each of the user accounts participating in the interactive live streaming (i.e., an anchor account side) acts as a push streaming side, which will push the live streaming data to the server side in real-time in the form of a stream.

The first point to clarify is that the embodiments of the present disclosure are illustrated only as an example of the execution of the method on the first terminal side. The execution of the method on the second terminal side is the same as this, which is not repeated herein.

The second point to clarify is that the third terminal corresponding to the audience account only needs to pull the live streaming data streams from the anchor account side, and the live streaming data streams from the anchor account side include the live streaming data streams of the first user account and the second user account. Subsequently, based on the pulled live streaming data streams, the third terminal displays the live streaming picture of the first user account and the live streaming picture of the second user account.

The third point to clarify is that at least one second user account includes the case where there is only one second user account and the case where there are two or more second user accounts.

In 202, the first terminal acquires a screen ratio corresponding to each of the first user account and the second user account, wherein the screen ratio corresponding to the first user account is determined according to an interaction value of the first user account and the screen ratio corresponding to the second user account is determined according to an interaction value of the second user account.

In some embodiments, the term “interaction value” herein refers to PK score, which is not limited in the present disclosure. In other words, the method associates the screen ratio corresponding to different anchors with the PK score. For example, high-scoring anchors can occupy a larger portion of the screen, effectively taking over the screen. Therefore, this new form of interaction during the interactive live streaming is also referred to as screen domination PK.

The screen ratio corresponding to each of the first user account and the second user account can either be acquired by the first terminal or sent to the first terminal by the server, or can either be acquired by the second terminal or sent to the second terminal by the server, which is not limited in the present disclosure.

In some embodiments, considering the limited computational capabilities of the terminal, taking the example of screen ratio being sent by the server, acquiring the screen ratio of each of the first user account and the second user account includes:
receiving, in the case that a preset condition is met, the screen ratio corresponding to each of the first user account and the second user account sent by the server,
wherein the preset condition includes at least one of:
a version number of the target application installed on a first terminal and a second terminal being greater than a preset version number;
a type of an interactive live streaming between the first user account and the second user account being of a preset interactive live streaming type;
an initiation mode of the interactive live streaming between the first user account and the second user account being of a preset initiation mode;
the number of followers of an initiator in the interactive live streaming between the first user account and the second user account being greater than a threshold number; and
both the interaction value of the first user account and the interaction value of the second user account being greater than a score threshold.

In the embodiments of the present disclosure, users are restricted from arbitrarily enabling a new interactive live streaming through the setting of preset conditions, which not only prevents the arbitrary use of permissions, but also reduces the computational load on the server.

In some embodiments, considering network conditions and taking the example of the first terminal independently acquiring the screen ratio, acquiring the screen ratio of each of the first user account and the second user account includes:
acquiring a current interaction value of each of the first user account and the second user account;
acquiring a screen ratio sent in the last time
determining, based on the current interaction value of each of the first user account and the second user account, an initial screen ratio;
determining, in the case that the difference between the initial screen ratio and the screen ratio sent in the last time is greater than a set threshold, a new screen ratio according to the screen ratio sent in the last time and a variation step size, wherein the variation step size is configured such that the new screen ratio is within a preset screen ratio range after adjustment by the variation step size; and
determining the new screen ratio as a screen ratio to be sent currently, that is, determining the new screen ratio as a screen ratio for this time.

In the case that the difference between the initial screen ratio and the screen ratio sent in the last time is not greater than the set threshold, the initial screen ratio is determined as a screen ratio to be sent currently.

In some embodiments, determining, based on the current interaction value of each of the first user account and the second user account, the initial screen ratio includes:
determining, based on the current interaction value of each of the first user account and the second user account, a current interaction value ratio between the first user account and the second user account;
acquiring a mapping relationship between an interaction value ratio and a screen ratio, wherein the mapping relationship includes a plurality of screen ratio levels; and
determining a screen ratio level corresponding to the current interaction value ratio based on the mapping relationship, and determining the initial screen ratio based on the screen ratio level.

In the embodiments of the present disclosure, the screen ratio is associated with the interaction value and the screen ratio sent in the last time, which can reflect the intensity of interaction between the first user account and the second user account through the screen ratio, and can avoid excessive difference in image display caused by large differences in screen ratios calculated in two adjacent calculations, ensuring display effects on the terminal side.

In addition, the aforementioned method for determining the initial screen ratio and the screen ratio to be sent currently can also be applied to the server, that is, the server can also determine the initial screen ratio and the screen ratio to be sent currently using the aforementioned method, which is not limited in the present disclosure.

In 203, the first terminal, based on the acquired screen ratio, displays the live streaming pictures of the first user account and the second user account on a live streaming interface of the first user account based on the acquired live streaming data streams from the first user account and the second user account.

The method for displaying live streaming data according to the embodiments of the present disclosure achieves a new way of display of interaction status during an interactive live streaming. Specifically, during an interactive live streaming with a plurality of user accounts, a dynamic screen ratio is acquired according to the interaction values of these user accounts, and the dynamic screen ratio is then used to render the live streaming pictures on the terminal side. In other words, in the method, the size of the display area of the live streaming picture is associated with the interaction value, which enriches the way of displaying the live streaming picture during the interactive live streaming and has a better display effect.

In some embodiments, displaying, based on the acquired screen ratio, the live streaming pictures of the first user account and the second user account on the live streaming interface of the first user account based on the live streaming data streams includes:
determining, under a current split-screen mode, a display area corresponding to each of the first user account and the second user account on the live streaming interface based on the acquired screen ratio, wherein the current split-screen mode may be a left-right split-screen mode or a top-bottom split-screen mode; and
displaying, in the determined display area, the live streaming picture of each of the first user account and the second user account based on the live streaming data streams.

Under the new interactive live streaming, the terminal dynamically determines, according to the acquired screen ratio, the size of the display area corresponding to each of the different user accounts, and the acquired screen ratio is then used to render the live streaming picture. This enables users to observe the current interaction status more visually, enriches the way of displaying the live streaming picture during an interactive live streaming and has a better display effect.

In some embodiments, displaying, in the determined display area, the live streaming picture of each of the first user account and the second user account based on the live streaming data streams includes:
displaying, in the case that a display area corresponding to the first user account is larger than a display area corresponding to the second user account, a live streaming picture of the first user account in the display area corresponding to the first user account based on a live streaming data stream of the first user account; and
displaying, based on a live streaming data stream of the second user account, a live streaming picture of the second user account in a first display area and a virtual resource in a second display area,
wherein the display area corresponding to the second user account includes the first display area and the second display area; a difference between the interaction value of the first user account and the interaction value of the second user account is inversely proportional to a size of the first display area and directly proportional to a size of the second display area.

In the embodiments of the present disclosure, in the case that the display area corresponding to the first user account is larger than the display area corresponding to the second user account, as the difference between the interaction value of the first user account and the interaction value of the second user account increases, the second display area becomes smaller. Correspondingly, the live streaming picture of the second user account is adaptively scaled to fit the current area size. In this case, in response to a mismatch between the display area and the video stream size, a black area, such as a black bar at the top or bottom, appears within the display area corresponding to the second user account. To ensure the display effect, the embodiments of the present disclosure use virtual resources to cover this portion of the area (the second display area).

It should be noted that the aforementioned “inversely proportional” refers to that the greater the difference between the interaction value of the first user account and the interaction value of the second user account, the smaller the size of the first display area; and “directly proportional” refer to that the greater the difference between the interaction value of the first user account and the interaction value of the second user account, the larger the size of the second display area in the display area corresponding to the second user account. In turn, the smaller the difference between the interaction value of the first user account and the interaction value of the second user account, the larger the size of the first display, and the smaller the size of the second display area.

In some embodiments, during the interactive live streaming, the method further includes:

canceling, in response to the size of the first display area being smaller than a first threshold, a display of the live streaming picture of the second user account and displaying, in a display form of not being covered by the virtual resource, identification information of the second user account in the display area corresponding to the second user account.

In addition, in the case that the size of the first display area becomes increasingly smaller, such as smaller than a first threshold, to ensure the user watching experience, the live streaming picture of the second user account is changed into the identification information of the second user account, such as the anchor's avatar.

In some embodiments, in response to the screen domination PK function on, the server sends configuration information to the terminal. The configuration information includes whether to compress the live streaming picture of a user account with the display area below a first threshold to audio only. Based on the configuration information, corresponding configuration items are displayed on the terminal side for user selection. In some PK scenarios, as the PK approaches its end, the PK score progress bar of the disadvantaged anchor account keeps getting smaller, while the live streaming picture of the disadvantaged anchor account is still visible. However, in some other PK scenarios, as the PK approaches its end, only the PK score progress bar of the disadvantaged anchor account gets smaller, the live streaming picture of the disadvantaged anchor account is replaced with the avatar of the anchor account, that is, the live streaming picture of the anchor account is no longer displayed.

It should be noted that canceling the display is to compress the live streaming data stream of the second user account to audio only, that is, to not display the live streaming picture of the second user account; or to cover with a layer of shelter on the live streaming picture of the second user account to cover the live streaming picture of the second user account, which is not limited in the present disclosure.

In some embodiments, the virtual resource is a virtual effect or a preset background image. In one example, the virtual effect is a freezing effect, which is a freezing effect on the screen, which gives the screen a frozen texture.

In some embodiments, the preset background image is a live streaming room cover of the second user account, a custom background image by the second user account, or a default background image, which is not limited in the present disclosure.

Displaying the virtual resource can ensure the display effect, and further enhance the visual appeal of the interaction status, and enrich the way of displaying the live streaming picture during the interactive live streaming.

It should be noted that during a screen domination PK, in addition to reflecting the intensity of interaction between the first user account and the second user account through the display size of the virtual resource, the intensity of interaction between the first user account and the second user account is also reflected by covering the live streaming picture dynamically.

In some embodiments, displaying, in the determined display area, the live streaming picture of each of the first user account and the second user account based on the live streaming data streams includes:
displaying, in the case that the display area corresponding to the first user account is larger than the display area corresponding to the second user account, the live streaming picture of the first user account in the display area corresponding to the first user account and the live streaming picture of the second user account in the display area corresponding to the second user account in a display form of covering the live streaming picture of the second user account with the live streaming picture of the first user account based on the live streaming data streams,
wherein the difference between the interaction value of the first user account and the interaction value of the second user account is directly proportional to the coverage range of the live streaming picture of the first user account over the live streaming picture of the second user account.

In some embodiments, during an interactive live streaming, the method further includes:
canceling, in response to the coverage range of the live streaming picture of the first user account over the live streaming picture of the second user account being greater than a second threshold, the display of the live streaming picture of the second user account, and displaying, in a display form of not being covered by the live streaming picture of the first user account, identification information of the second user account in the display area corresponding to the second user account.

In some embodiments, the aforementioned “covering dynamically” refers to that, in the case that the display area corresponding to the first user account is larger than the display area corresponding to the second user account, as the difference between the interaction value of the first user account and the interaction value of the second user account increases, the live streaming picture of the first user account dynamically covers the live streaming picture of the second user account. In this case, the live streaming picture of the second user account is gradually covered, for example, a complete face is shown initially, then only half of the face is shown, and finally, the live streaming picture of the second user account is not displayed and the avatar of the anchor is displayed.

In some embodiments, during an interactive live streaming, the method further includes:
displaying, in response to receiving a feedback instruction, the live streaming picture of each of the first user account and the second user account on the live streaming interface in a screen ratio corresponding to a half and half split-screen mode based on the acquired live streaming data streams, wherein under the half and half split screen mode, display area of the live streaming pictures of the first user account and the second user account is the same,
wherein the feedback instruction is generated based on a trigger operation by either the first user account or the second user account on a target control, the target control being configured to cancel a display of the live streaming pictures according to screen ratios determined by the interaction values.

In some embodiments, acquiring the screen ratio corresponding to each of the first user account and the second user account includes:
acquiring, in the case that a preset function from the target application is enabled, the screen ratio corresponding to each of the first user account and the second user account,
wherein the preset function is configured to enable displaying live streaming pictures according to screen ratios determined by the interaction values.

The embodiments of the present disclosure not only support users in freely choosing to enable a new interactive live streaming, but also support users in freely choosing to exit a new interactive live streaming, providing better flexibility.

In some embodiments, during an interactive live streaming, the method further includes:
displaying, according to the interaction value of the first user account and the interaction value of the second user account, a progress display control based on a size of the live streaming interface,
wherein a length of the progress display control is the same as a width or a height of the live streaming interface, and the progress display control displays a progress bar corresponding to each of the first user account and the second user account, a length of each progress bar being determined based on an interaction value of a corresponding user account.

By displaying the progress bar in the progress display control corresponding to the user account participating in the interactive live streaming, users can visually see the interaction status through the progress bar, which enriches the display form of interaction status during an interactive live streaming and has a better display effect.

In some embodiments, in response to a difference in the progress bar lengths between the first user account and the second user account falling within a first interval, a display area boundary between the first user account and the second user account aligns with a progress bar boundary.

The embodiments of the present disclosure dynamically reflect the interaction values of user accounts participating in the interactive live streaming by combining the progress bar and the size of the display area, which enriches the display form of interaction status during an interactive live streaming and has a better display effect.

In some embodiments, in response to the difference in the progress bar lengths between the first user account and the second user account falling within the second interval, the display area boundary between the first user account and the second user account is staggered with the progress bar boundary, wherein left boundary value a of the first interval is smaller than left boundary value of a second interval b, and right boundary value c of the first interval is smaller than right boundary value d of the second interval. That is, the second interval is greater than the first interval. For example, a is 2, b is 4, c is 5, and d is 7. The difference in the progress bar lengths between the first user account and the second user account is directly proportional to a degree of staggering between the display area boundary and the progress bar boundary.

The aforementioned “directly proportional” refers to that the greater the difference in the progress bar lengths between the first user account and the second user account, the greater the degree of staggering between the display area boundary and the progress bar boundary; and the smaller the difference in the progress bar lengths between the first user account and the second user account, the smaller the degree of staggering between the display area boundary and the progress bar boundary.

In the case that the difference in the progress bar lengths between different user accounts is small, the display area boundary aligns with the progress bar boundary; in the case that the difference in the progress bar lengths between different user accounts is large, the display area boundary is staggered with the progress bar boundary. This display method reflects the intensity of interaction between different user accounts and avoids excessive reduction of the display area for disadvantaged users, further ensuring display effects and enhancing user experience.

All of the aforementioned optional technical solutions can be combined in any way to form various optional embodiments of the present disclosure, which are not repeated herein.

FIG. 3 is a flowchart showing another method for displaying live streaming data according to some embodiments of the present disclosure. As shown in FIG. 3, the method for displaying live streaming data is applied to an electronic device, such as the server shown in FIG. 1. The method for displaying live streaming data includes the following processes.

In 301, the server, during an interactive live streaming, sends a live streaming data stream of at least one second user account participating in the interactive live streaming to a first terminal corresponding to a first user account.

Taking the number of the second user account being one as an example, during the interactive live streaming, the server further sends a live streaming data stream of the first user account to a second terminal corresponding to the second user account, and sends the live streaming data streams of the first user account and the second user account to a third terminal corresponding to a third user account.

In 302, the server determines, according to an interaction value of each of the first user account and the second user account, a screen ratio corresponding to each of the first user account and the second user account.

In some embodiments, the server acquires the screen ratio according to the interaction value. The interaction value reflects the intensity of interaction between the first user account and the second user account.

In 303, the server sends the screen ratio corresponding to each of the first user account and the second user account to the first terminal, wherein the first terminal is configured to display, based on the acquired screen ratio, live streaming pictures of the first user account and the second user account on a live streaming interface of the first user account based on the live streaming data streams of the first user account and the second user account.

In the method for displaying live streaming data according to the embodiments of the present disclosure, during an interactive live streaming with a plurality of user accounts, a dynamic screen ratio is acquired according to the interaction values between these user accounts, and the dynamic screen ratio is then used to render the live streaming picture on the terminal side. In other words, in the method, the size of the display area for the live streaming picture is associated with the interaction value, which enriches the way of displaying the live streaming picture during the interactive live streaming and has a better display effect.

In some embodiments, determining, according to the interaction value of each of the first user account and the second user account, the screen ratio corresponding to each of the first user account and the second user account includes:
acquiring a current interaction value of each of the first user account and the second user account;
acquiring a screen ratio sent in a last time; and
determining, based on the current interaction value of each of the first user account and the second user account and the screen ratio sent in the last time, the screen ratio to be sent currently;
and sending the screen ratio corresponding to each of the first user account and the second user account to the first terminal includes: determining, in response to a difference between the screen ratio to be sent currently and the screen ratio sent in the last time, the screen ratio to be sent currently as a new screen ratio corresponding to each of the first user account and the second user account and sending the new screen ratio to the first terminal.

In the embodiments of the present disclosure, the screen ratio is associated with the interaction value and the screen ratio sent in the last time, which can reflect the intensity of interaction between the first user account and the second user account through the screen ratio, and can avoid excessive difference in image display caused by large differences in screen ratios calculated in two adjacent calculations, ensuring display effects on the terminal side and imposing low demands on the display performance of the terminal.

In some embodiments, determining, according to the interaction value of each of the first user account and the second user account, the screen ratio corresponding to each of the first user account and the second user account includes:
determining, in response to meeting a preset condition, the screen ratio corresponding to each of the first user account and the second user account according to the interaction value of each of the first user account and the second user account, wherein the preset condition includes at least one of:

a version number of the target application installed on a first terminal and a second terminal being greater than a preset version number, wherein the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of an initiator in the interactive live streaming between the first user account and the second user account being greater than a threshold number; and
both the interaction value of the first user account and the interaction value of the second user account being greater than a score threshold.

In the embodiments of the present disclosure, users are restricted from arbitrarily enabling a new interactive live streaming by setting preset conditions, which not only prevents the arbitrary use of permissions, but also reduces the computational load on the server.

In some embodiments, sending the screen ratio corresponding to each of the first user account and the second user account to the first terminal includes:
acquiring a change event during the interactive live streaming, wherein the change event is configured to change a current live streaming picture layout;
acquiring, in a case that there are a plurality of change events, a candidate change event by sorting the plurality of change events, and categorizing by priority and filtering the sorted change events; and
sending, in response to the current pending candidate change event configured to indicate displaying the live streaming pictures according to a screen ratio, the screen ratio of each of the first user account and the second user account to the first terminal.

In some embodiments, acquiring the candidate change event by sorting the plurality of change events, and categorizing by priority and filtering the sorted change events includes:
acquiring the sorted change events by sorting the plurality of change events in chronological order; and
acquiring the candidate change event by categorizing the sorted change events by priority according to business types thereof and filtering out duplicate filterable change events,
wherein the filterable change events include events related to displaying live streaming pictures according to a screen ratio.

The embodiments of the present disclosure avoid the problem of concurrent layout on the terminal side, thereby preventing layout disorder on the terminal side.

In some embodiments, during an interactive live streaming, the method further includes:
acquiring the number of likes and the number of virtual resources gifted by a third user account to the first user account;
acquiring the number of likes and the number of virtual resources gifted by the third user account to the second user account;
determining, based on at least one of the number of likes and the number of virtual resources corresponding to the first user account, the interaction value of the first user account; and
determining, based on at least one of the number of likes and the number of virtual resources corresponding to the second user account, the interaction value of the first user account.

The interaction value is determined based on at least one of the number of likes and the number of virtual resources gifted by the third user account, making it a better way to reflect the quality of the live streaming and the popularity of the first user account and the second user account.

All of the aforementioned optional technical solutions can be combined in any way to form various optional embodiments of the present disclosure, which are not repeated herein.

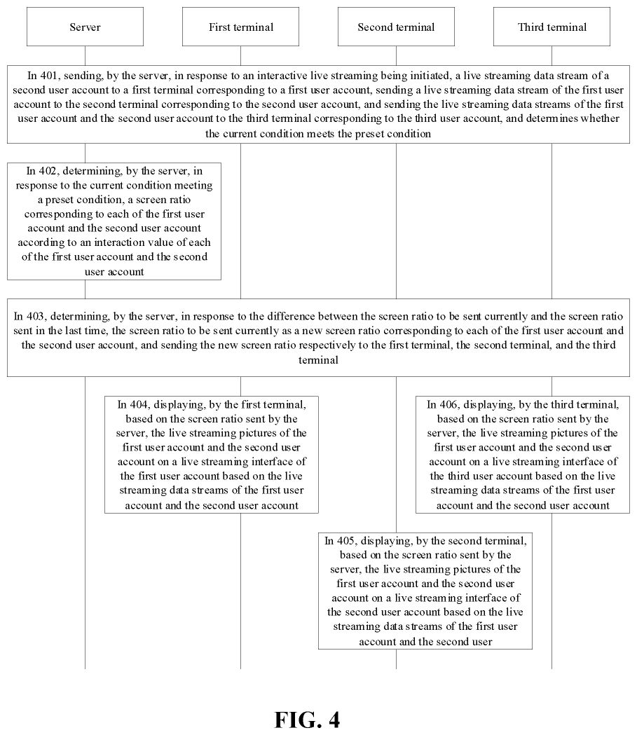

The aforementioned FIGS. 2 and 3 illustrate only the basic process of the present disclosure. Based on a specific implementation, the method provided by the present disclosure is further explained. FIG. 4 is a flowchart showing another method for displaying live streaming data according to some embodiments of the present disclosure. Taking an interaction between terminals and a server as an example, in the case that there is one second user account, as shown in FIG. 4, the method for displaying live streaming data includes the following processes.

In 401, the server, in response to an interactive live streaming being initiated, sends a live streaming data stream of a second user account to a first terminal corresponding to a first user account, sends a live streaming data stream of the first user account to a second terminal corresponding to the second user account, and sends the live streaming data streams of the first user account and the second user account to a third terminal corresponding to a third user account, and determines whether a current condition meets a preset condition.

The user accounts participating in the interactive live streaming include the first user account and the second user account. That is, the first user account and the second user account are anchor accounts.

In some embodiments, the interactive live streaming is initiated by the first user account or the second user account. Taking an initiator of an interactive live streaming being the first user account as an example, the process of initiating the interactive live streaming includes:

The first terminal, based on the logged-in first user account, sends an interaction request to the server. The interaction request is configured to request an interactive live streaming with the second user account. Subsequently, the server forwards the interaction request to the second terminal. Upon detecting that the logged-in second user account has consented to the interaction operation, the second terminal sends feedback information indicating consent for the interaction to the server. After receiving the feedback information, the server begins to push the live streaming data stream of the second user account to the first terminal, push the live streaming data stream of the first user account to the second terminal, and push the live streaming data streams of the first user account and the second user account to the third terminal.

It should be noted that during the interactive live streaming, the number of third user accounts that are audience accounts is subject to change. For example, a new third user account joins the live streaming room, or the existing audience leaves the live streaming room. Additionally, the first user account and the second user account engage in the interactive live streaming within the same live streaming room or in different live streaming rooms, which is not limited in the present disclosure.

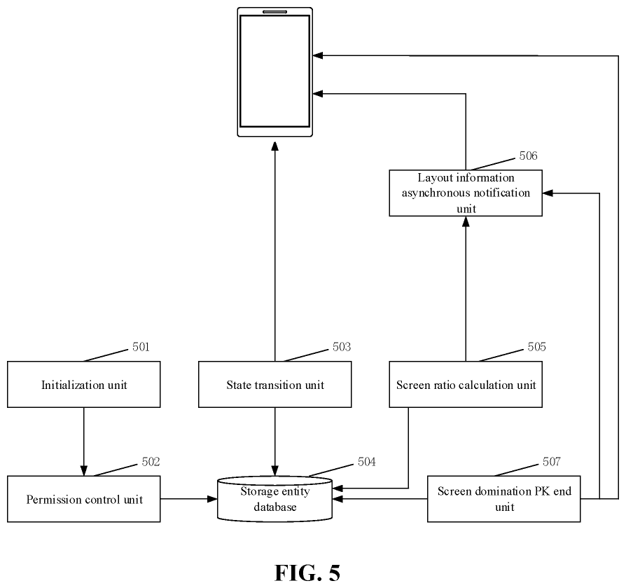

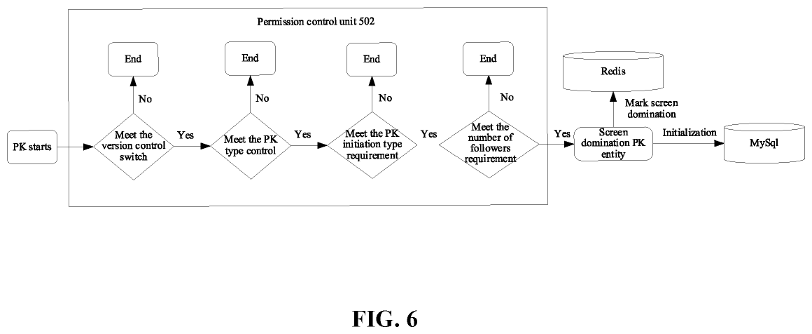

FIG. 5 is an architectural schematic diagram showing a scheme for displaying live streaming data according to some embodiments of the present disclosure. Some components of the server, the communications of the components with a terminal, and communication among the components are illustrated in FIG. 5. In some embodiments, based on an architecture diagram shown in FIG. 5, the server dynamically acquires the screen ratio based on the interaction value during the interactive live streaming. As shown in FIG. 5, the server determines whether the current condition meets the preset condition through the initialization unit 501, permission control unit 502, and state transition unit 503. The storage entity database 504 in FIG. 5 is a combination of the Redis database and MySQL database shown in FIG. 6, which is not limited in the present disclosure. In addition, FIG. 6 only illustrates the Redis database and MySQL database as examples, and other types of databases can be used to replace the mentioned databases, which are not limited in the present disclosure.

In some embodiments, the preset condition includes at least one of the following.

First, a version number of the target application is greater than a preset version number.

In this case, the target application is installed on the first terminal, the second terminal, and the third terminal, and the first user account, the second user account, and the third user account are logged in on the first terminal, the second terminal, and the third terminal, respectively. In some embodiments, the version number of the target application being greater than the preset version number indicates that the version number of the target application installed on the first terminal and the second terminal is greater than the preset version number, which is not limited in the present disclosure.

Second, a type of an interactive live streaming between the first user account and the second user account is of a preset interactive live streaming type.

In this case, the type of the interactive live streaming includes, but is not limited to, two-player PK, multi-player PK, and the like, which is not limited in the present disclosure.

Third, an initiation mode of the interactive live streaming between the first user account and the second user account is of a preset initiation mode.

In this case, the initiation mode of the interactive live streaming includes, but is not limited to, random matching, friend PK, and the like, which is not limited in the present disclosure.

Fourth, the number of followers of an initiator in the interactive live streaming between the first user account and the second user account is greater than a threshold number.

This process can also be replaced with both the first user account and the second user account having the number of followers being greater than the threshold number, which is not limited in the present disclosure.

Fifth, both the interaction value of the first user account and the interaction value of the second user account are greater than a score threshold.

This process is configured to determine whether the PK score has reached a score threshold to initiate a screen domination PK. Taking the two-player PK as an example, both parties have a PK score of more than 100 points to initiate a screen domination PK.

Referring to FIG. 6, FIG. 6 is a flowchart showing a first scheme for displaying live streaming data according to some embodiments of the present disclosure. In some embodiments, the initialization unit 501 is configured to asynchronously trigger the initialization of screen domination PK according to the PK start message, during which permissions and status are verified by the permission control unit 502. The PK start message is a Kafka message, which is not limited in the present disclosure. In FIG. 6, the permission control unit 502 first verifies the version number of the target application, i.e., determines whether the requirement of the version control switch is met; if the version control switch is met, the process proceeds to the next process, where the permission control unit continues to determine whether the PK type control requirement is met; if the requirement is still met, the process proceeds to the next step process where the permission control unit continues to determine whether the PK initiation type requirement is met; if the requirement is yet still met, the process proceeds to the next process, where the permission control unit continues to determine whether the number of followers requirement is met; if the requirement is met, the permission control process ends, the current interactive live streaming is then marked as a screen domination PK and is stored in the Redis database. Simultaneously, initialization data is stored in the MySQL database. The initialization data is configured to represent that the current interactive live streaming has initiated a screen domination PK. In some embodiments, the screen domination PK entity in FIGS. 6 to 8 represents all data that can mark the current screen domination PK, such as the ID and current status of the current screen domination PK, which is not limited in the present disclosure.

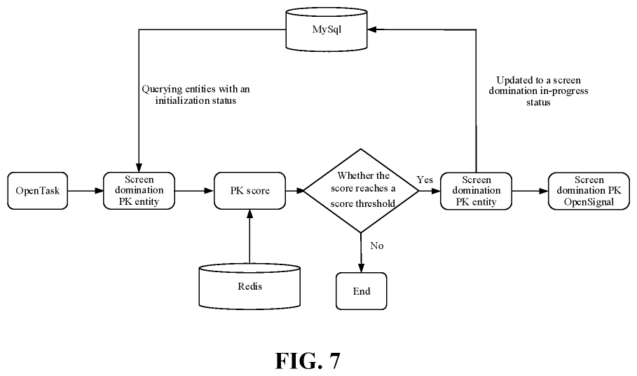

Referring to FIG. 7, FIG. 7 is a flowchart showing a second scheme for displaying live streaming data according to some embodiments of the present disclosure. In some embodiments, the workflow of the state transition unit 503 involves querying the MySQL database for screen domination PK entities with an initialization status and determining whether the PK score has reached a score threshold required to initiate a screen domination PK, wherein the PK score is acquired from the Redis database. If the PK score reaches the score threshold, the related screen domination PK entities in the MySQL database are updated to a screen domination in-progress status. Subsequently, an instruction to initiate the screen domination PK is sent via a long link to both live streaming rooms participating in the interactive live streaming.

In 402, the server, in response to the current condition meeting a preset condition, determines a screen ratio corresponding to each of the first user account and the second user account according to an interaction value of each of the first user account and the second user account.

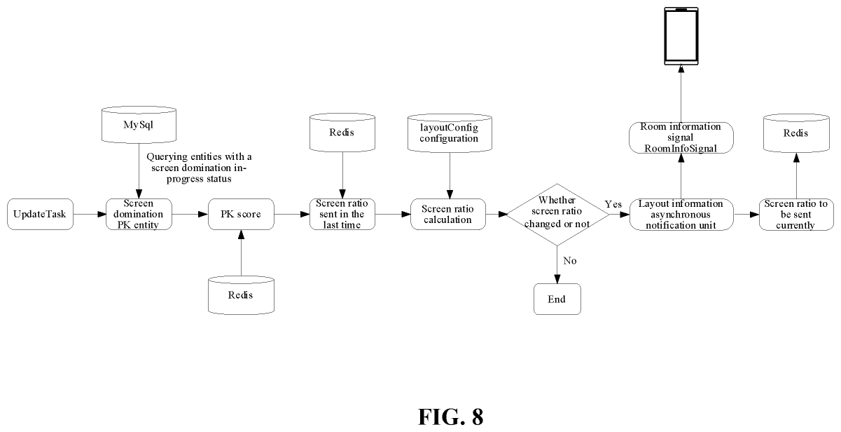

As shown in FIG. 5, the server calculates the screen ratio by the screen ratio calculation unit 505. Referring to FIG. 8, FIG. 8 is a flowchart showing a third scheme for displaying live streaming data according to some embodiments of the present disclosure. In some embodiments, as shown in FIG. 8, the workflow of the screen ratio calculation unit 505 includes: querying entities with a screen domination in-progress status, acquiring the corresponding PK scores, and then recalculating a new screen ratio according to the layoutConfig rule and the screen ratio sent in the last time. The newly calculated screen ratio is compared with the screen ratio sent in the last time. In the case that there is any change, the current calculated result is saved, and the layout information asynchronous notification unit 506 is invoked to send a room information signal (roomInfoSignal), informing the terminal side to render the live streaming picture according to the new screen ratio.

In some embodiments, during the interactive live streaming, the interaction values of the first user account and the second user account are calculated as follows:
acquiring the number of likes and the number of virtual resources gifted by a third user account to the first user account;
acquiring the number of likes and the number of virtual resources gifted by a third user account to the second user account;
determining, based on at least one of the number of likes and the number of virtual resources corresponding to the first user account, the interaction value of the first user account; and
determining, based on at least one of the number of likes and the number of virtual resources corresponding to the second user account, the interaction value of the first user account.

As the number of likes and the number of virtual resources gifted by audience accounts increase, the interaction value of the corresponding user account becomes higher. The level of interaction value directly reflects the quality and popularity of the corresponding anchor's live streaming.

In some embodiments, determining, according to the interaction value of each of the first user account and the second user account, the screen ratio corresponding to each of the first user account and the second user account includes:
acquiring a current interaction value of each of the first user account and the second user account;
acquiring a screen ratio sent in the last time corresponding to each of the first user account and the second user account; and
determining, based on the current interaction value of each of the first user account and the second user account and the screen ratio sent in the last time, a screen ratio to be sent currently.

Exemplarily, during calculating the current screen ratio, the initial screen ratio is firstly determined based on the current interaction value of each of the first user account and the second user account. If the difference between the initial screen ratio and the screen ratio sent in the last time is greater than a set threshold, a new screen ratio is determined according to the screen ratio sent in the last time and a preset variation step size. The new screen ratio is used as the screen ratio to be sent currently.

It should be noted that the layoutConfig rule defines different levels for screen ratio. In some embodiments, the levels are divided based on the ratio of interaction values between different user accounts. For example, the screen ratio is divided into ten levels based on the ratio between the interaction values. For example, assuming that in the previous calculation, the interaction value for the first user account was 100, and the interaction value for the second user account was 900, resulting in a ratio of 1:9 between their interaction values, the interaction value ratio for the first user account was 10%, which falls into the first level among the ten levels. In the first level, the screen ratio for the first user account was 10%, and the screen ratio for the second user account was 90%.

For another example, assuming that in the current calculation, the interaction value for the first user account is 200, and the interaction value for the second user account is 800, resulting in a ratio of 2:8 between their interaction values, the interaction value ratio for the first user account is 20%, which falls into the second level among the aforementioned ten levels. In the second level, the screen ratio for the first user account is 20%, and the screen ratio for the second user account is 80%.

For another example, assuming that in the current calculation, the interaction value for the first user account is 2000000, and the interaction value for the second user account is still 900, then the screen ratio for the first user account may fall into the tenth level among the aforementioned ten levels. However, since the previously calculated screen ratio for the first user account was in the first level, and now it jumps to the tenth level, resulting in a significant change in the screen ratio, the level is re-determined according to the screen ratio sent in the last time and the preset variation step size. Assuming that the preset variation step size is 2, then the re-determined screen ratio would be in the third level.

In 403, the server, in response to the difference between the screen ratio to be sent currently and the screen ratio sent in the last time, determines the screen ratio to be sent currently as a new screen ratio corresponding to each of the first user account and the second user account, and sends the new screen ratio respectively to the first terminal, the second terminal, and the third terminal.

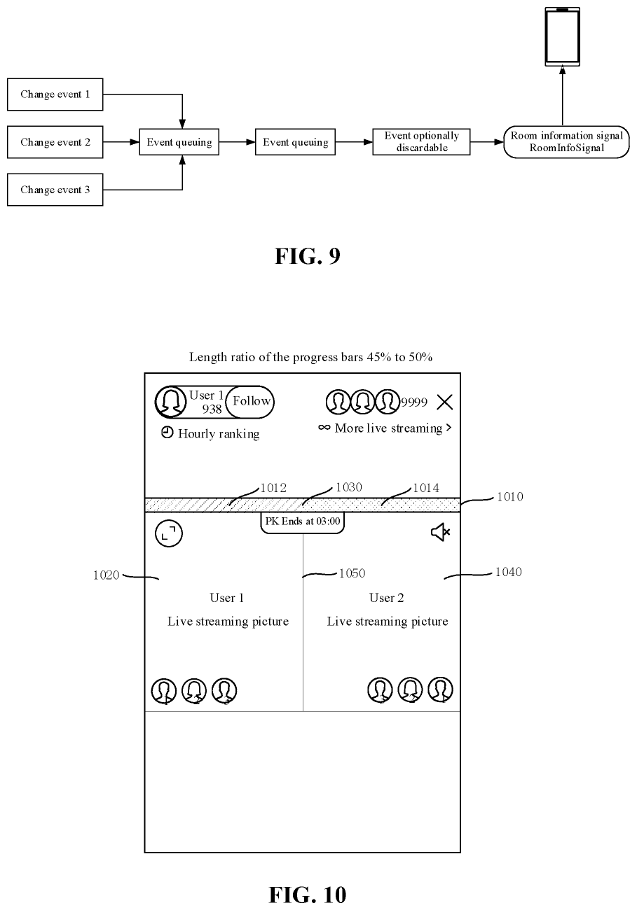

This process is executed by the layout information asynchronous notification unit 506, as shown in FIG. 5. Referring to FIG. 9, FIG. 9 is a flowchart showing a fourth scheme for displaying live streaming data according to some embodiments of the present disclosure. In the embodiments of the present disclosure, as shown in FIG. 9, the layout information asynchronous notification unit 506 collects change events, categorizes the change events by priority, performs global rate control, such as discarding events that can be discarded, and then assembles the roomInfoSignal according to specific business types, to notify the terminal side to render the live streaming picture. FIG. 9 just illustrates an example with three change events, and in practice, the number of change events may be more or less, which is not limited in the present disclosure. The change event is configured to change the current live streaming picture layout. The type of the change event includes, but is not limited to, the event that indicates displaying the live streaming picture according to the screen ratio, the event that indicates a user account joining the interactive live streaming, the event that indicates a user account exiting the interactive live streaming.

In some embodiments, sending the screen ratio corresponding to each of the first user account and the second user account includes the following processes 4031 to 4033.

In 4031, a change event is acquired during the interactive live streaming. In the embodiments of the present disclosure, the change event is collected by the layout information asynchronous notification unit 506.

In 4032, in the case that there are a plurality of change events, a candidate change event is acquired by sorting the plurality of change events, and categorizing by priority and filtering the sorted change events.

In some embodiments, the plurality of change events are sorted in chronological order to acquire the sorted change events. Subsequently, the sorted change events are categorized by priority according to business types thereof, and duplicate filterable change events are filtered to acquire the candidate change event, wherein the filterable change events include events related to displaying live streaming pictures according to a screen ratio. That is, screen ratio calculations occur at intervals. To avoid problems of concurrency and layout disorder due to frequent computations, as well as to reduce the computational load on the server, a portion of this type of change events are discarded. In other words, by discarding a portion of this type of change events, the frequency of sending the screen ratio to the terminal side is reduced. In addition, change events related to anchors joining or exiting the interactive live streaming are considered non-filterable change events.

In 4033, in response to the current pending candidate change event configured to indicate displaying the live streaming picture according to the screen ratio, the screen ratio of each of the first user account and the second user account is sent to the first terminal, the second terminal, and the third terminal.

In the queue of pending candidate change events, in the case that the current pending candidate change event is configured to indicate displaying the live streaming picture according to the screen ratio, and since the change event is not filtered out and is currently at the front of the queue, the screen ratio of each of the first user account and the second user account is directly sent to the first terminal, the second terminal, and the third terminal.

In some embodiments, the server calculates and sends the screen ratio corresponding to each of the first user account and the second user account only in the case that the preset function from the target application installed on the first terminal and the second terminal is enabled, wherein the preset function is configured to enable displaying the live streaming pictures according to the screen ratio determined by the interaction values.

In 404, the first terminal, based on the screen ratio sent by the server, displays the live streaming pictures of the first user account and the second user account on a live streaming interface of the first user account based on the live streaming data streams of the first user account and the second user account.

In some embodiments, displaying, based on the acquired screen ratio, the live streaming pictures of the first user account and the second user account on the live streaming interface of the first user account based on the live streaming data streams of the first user account and the second user account includes: determining, under a current split-screen mode, a display area corresponding to each of the first user account and the second user account on the live streaming interface based on the acquired screen ratio; and displaying, in the determined display area, the live streaming picture of each of the first user account and the second user account based on the live streaming data streams of the first user account and the second user account. The current split-screen mode includes left-right split-screen mode or top-bottom split-screen mode, which is not limited in the present disclosure.

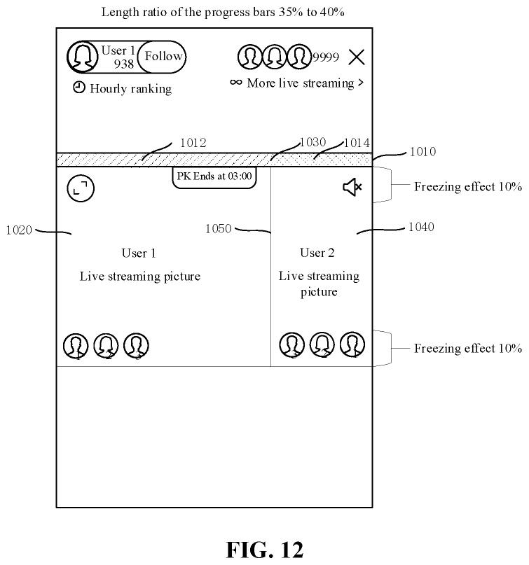

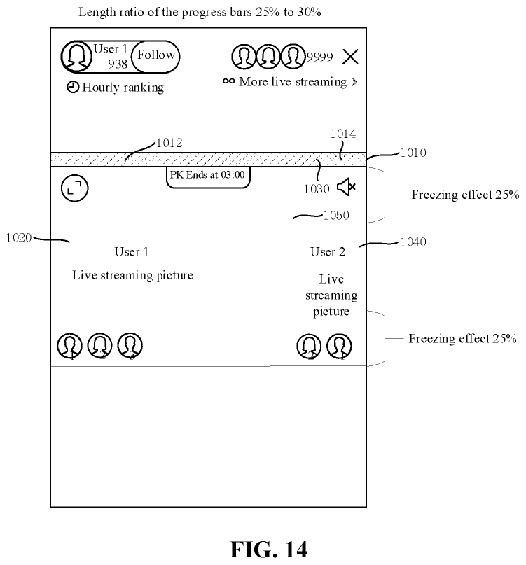

In some embodiments, during the interactive live streaming, as shown in FIGS. 10 to 15, a progress display control 1010 is also shown. The progress display control 1010 displays a progress bar 1012 corresponding to the first user account and a progress bar 1014 corresponding to the second user account. The terminal side, according to the interaction value of each of the first user account and the second user account, displays the progress display control based on the size of the live streaming interface. The length of the progress display control may be the same as the width or height of the live streaming interface. In the examples illustrated in FIG. 10-15, the progress display control 1010 is the same as the width of the live streaming interface. The progress display control 1010 displays a progress bar 1012, 1014 corresponding to each of the first user account and the second user account, the length of each progress bar being determined based on an interaction value of a corresponding user account.

In some embodiments, in the case that the intensity of interaction between the first user account and the second user account is reflected by the size of the display range of the virtual resource, displaying, in the determined display area, the live streaming picture of each of the first user account and the second user account based on the live streaming data streams includes:
displaying, in the case that a display area corresponding to the first user account is larger than a display area corresponding to the second user account, a live streaming picture of the first user account in the display area corresponding to the first user account based on the live streaming data stream of the first user account; and
displaying, based on the live streaming data stream of the second user account, the live streaming picture of the second user account in a first display area and the virtual resource in a second display area, wherein the display area corresponding to the second user account includes the first display area and the second display area; and a difference between the interaction value of the first user account and the interaction value of the second user account is inversely proportional to a size of the first display area and directly proportional to a size of the second display area.

It should be noted that the aforementioned display of the live streaming picture and the virtual resource is illustrated in the embodiments shown in FIG. 2, and is not further repeated herein.

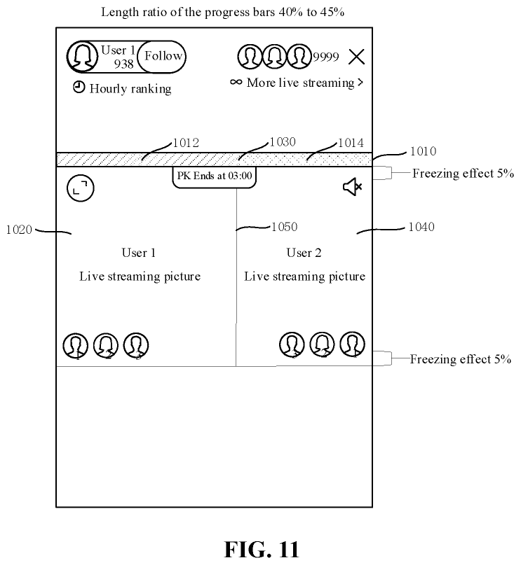

In some embodiments, taking the example of the virtual resource as a virtual effect, as shown in FIGS. 11 to 15, as the interaction value difference increases, the coverage range of the virtual effect increases from 5%, 10%, 15%, 25% to 100%, i.e., complete coverage. In addition, the virtual effect is any type of virtual effect capable of creating a coverage effect, and FIGS. 11 to 15 only illustrates a virtual effect that creates a freezing effect.

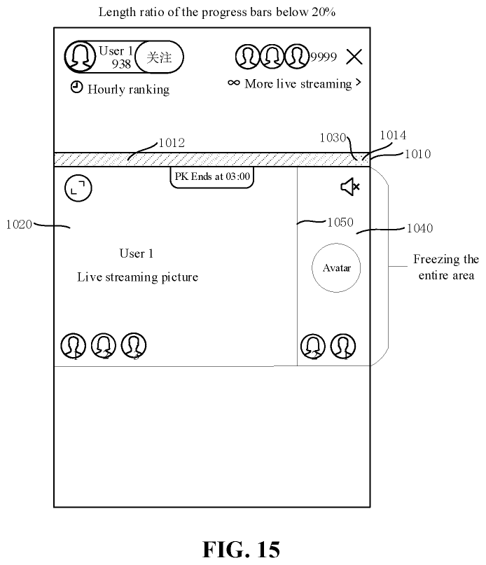

In some embodiments, as shown in FIG. 15, during the interactive live streaming, the method according to the embodiments of the present disclosure further includes: canceling, in response to the size of the first display area being smaller than a first threshold, a display of the live streaming picture of the second user account, and displaying, in a display form of not being covered by the virtual resource, identification information of the second user account in the display area corresponding to the second user account. The identification information is an avatar of the second user account, which is not limited in the present disclosure.

In some embodiments, as shown in FIGS. 10 to 12, in the case that there is only one second user account, in response to the difference in the progress bar lengths between the first user account and the second user account falling within the first interval, the display area boundary 1050 between the first user account and the second user account aligns with the progress bar boundary 1030 between the first user account and the second user account. In the examples illustrated in FIGS. 10-15, the length of the display area boundary corresponding to both the first user account and the second user account is the same as the length of the progress bar control 1010. The length ratio of the progress bars shown in FIGS. 10 to 12 is the length ratio of the progress bars for the second user account. In FIGS. 10-12, the length of the progress bar 1012 of the first user account aligns with the corresponding boundary of the display area 1020 of the first user account, and the length of the progress bar 1014 of the second user account aligns with the corresponding boundary of the display area 1040 of the second user accounts.

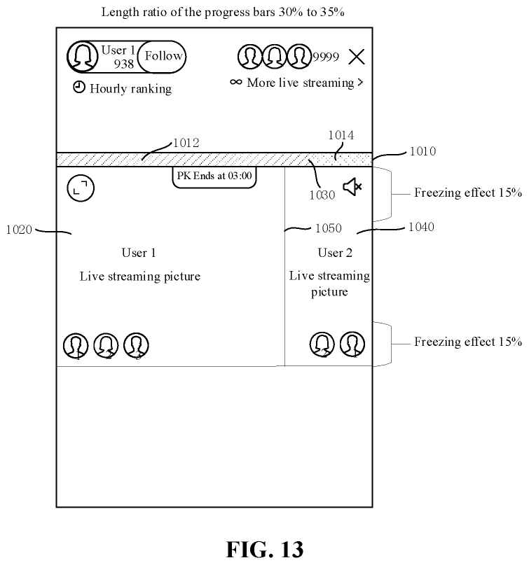

In some embodiments, as shown in FIGS. 13 to 15, in the case that there is only one second user account, in response to the difference in the progress bar lengths between the first user account and the second user account falling within the second interval, the display area boundary 1050 between the first user account and the second user account does not align with the progress bar boundary 1030 between the first user account and the second user account, that is, the display area boundary 1050 between the first user account and the second user account is staggered with the progress bar boundary 1030 between the first user account and the second user account. The second interval is greater than the first interval, that is, the difference in the progress bar lengths between the first user account and the second user account is greater. In this case, as shown in FIGS. 13 to 15, the length of the progress bar 1012 of the first user account is greater than the length of the corresponding boundary of the display area 1020 of the first user account. The greater the difference in the progress bar lengths between the first user account and the second user account, the greater the degree of staggering between the display area boundary and the progress bar boundary.

It should be noted that the above illustration is based on the case of a single second user account. In the case that there are two or more second user accounts, i.e., a multi-player screen domination PK, to reflect the intensity of interaction among the plurality of anchors, a similar method can be used for displaying the live streaming picture of each of the user accounts. In some embodiments, among the plurality of user accounts participating in the interaction, the size of the display area of each user account for the live streaming picture is directly proportional to the current interaction value of the user account. For example, the user account with the lowest interaction value displays only the avatar thereof and no corresponding live streaming picture, the user account with the second-lowest interaction value only displays the corresponding live streaming picture in a small display area (e.g., 20%), the user account with the third-lowest interaction value only displays the corresponding live streaming picture in another small display area (e.g., 30%), and so on, which is not limited in the present disclosure.

In 405, the second terminal, based on the screen ratio sent by the server, displays the live streaming pictures of the first user account and the second user account on a live streaming interface of the second user account based on the live streaming data streams of the first user account and the second user account.

This process is similar to 404 and is not further repeated herein.

In 406, the third terminal, based on the screen ratio sent by the server, displays the live streaming pictures of the first user account and the second user account on a live streaming interface of the third user account based on the live streaming data streams of the first user account and the second user account.

This process is similar to 404 and is not further repeated herein.

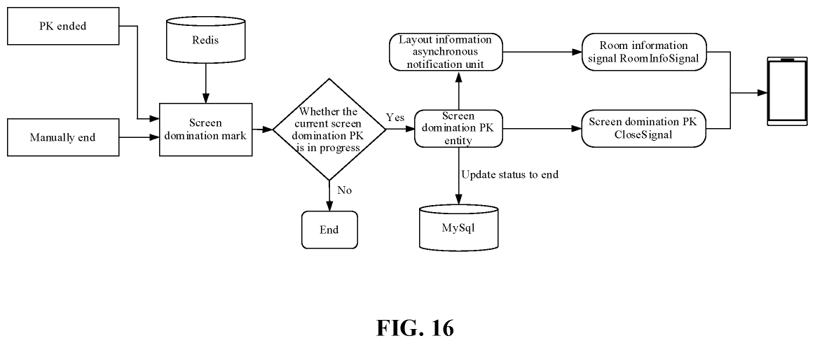

In the embodiments of the present disclosure, as shown in FIG. 5, there is also a screen domination PK end unit 507. As shown in FIG. 16, the embodiments of the present disclosure support ending the screen domination PK in two ways. In one way, in the case that the current interactive live streaming ends, the interactive PK itself ends. In another way, the anchor participating in the interactive live streaming manually closes the screen domination PK.

As shown in FIG. 16, the workflow of the screen domination PK end unit 507 is as follows: in the case that a PK end message is received or an anchor manually triggering the end of the PK is determined, the screen domination mark for the current screen domination PK is acquired from the Redis database, whether the current screen domination PK is still in progress is determined based on the screen domination mark; if it is, after the status of the corresponding entity is updated to end, the current screen domination PK is stored in the MySQL database, a message indicating the end of the screen domination is sent to the terminal side, and the terminal side removes the UI elements related to screen domination. In addition, the screen domination PK end unit also notifies the layout information asynchronous notification unit 506 to assemble a new roomInfoSignal to restore the previous live streaming picture ratio.

In some embodiments, during the interactive live streaming, the method according to the embodiments of the present disclosure further includes:
displaying, in response to receiving a feedback instruction, the live streaming picture of each of the first user account and the second user account on the live streaming interface in a screen ratio corresponding to the current split-screen mode based on the live streaming data stream,
wherein the feedback instruction is generated based on a trigger operation by either the first user account or the second user account on a target control, the target control being configured to cancel a display of live streaming pictures according to screen ratios determined by interaction values, for example, the live streaming pictures are displayed in an evenly-split-screen manner before the end of the current interactive live streaming. In some embodiments, the target control is displayed on the live streaming interfaces of the first user account and the second user account, which is not limited in the present disclosure.

In the method for displaying live streaming data according to the embodiments of the present disclosure, during an interactive live streaming with a plurality of user accounts, a dynamic screen ratio according to the interaction values of these user accounts is acquired, and the dynamic screen ratio is then used to render the live streaming picture on the terminal side. In other words, in the method, the size of the display area of the live streaming picture is associated with the interaction value, which enriches the way of displaying the live streaming picture during the interactive live streaming and has a better display effect.

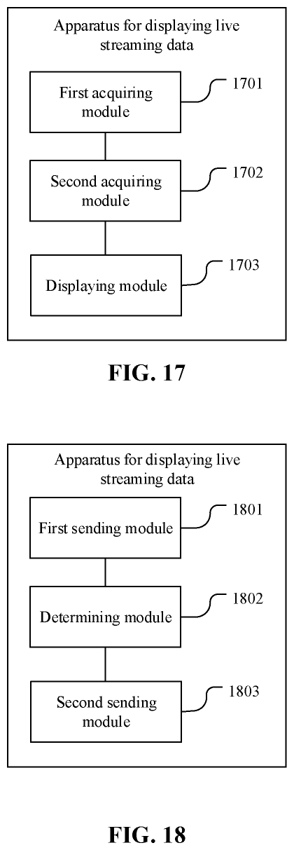

FIG. 17 is a block diagram showing an apparatus for displaying live streaming data according to some embodiments of the present disclosure. Referring to FIG. 17, the apparatus includes:
a first acquiring module 1701, configured to acquire, during an interactive live streaming, live streaming data streams of a first user account and at least one second user account participating in the interactive live streaming;
a second acquiring module 1702, configured to acquire a screen ratio corresponding to each of the first user account and the second user account, wherein the screen ratio corresponding to the first user account is determined according to an interaction value of the first user account and the screen ratio corresponding to the second user account is determined according to an interaction value of the second user account; and
a displaying module 1703, configured to display, based on the acquired screen ratio, live streaming pictures of the first user account and the second user account on a live streaming interface of the first user account based on the live streaming data streams.

In the apparatus for displaying live streaming data according to the embodiments of the present disclosure, during an interactive live streaming with a plurality of user accounts, a dynamic screen ratio is acquired according to the interaction values between these user accounts, and the dynamic screen ratio is then used to render the live streaming picture on the terminal side. In other words, in the apparatus, the size of the display area for the live streaming picture is associated with the interaction value, which enriches the way of displaying the live streaming picture during the interactive live streaming and has a better display effect.

In some embodiments, the displaying module is configured to:
determine, under a current split-screen mode, a display area corresponding to each of the first user account and the second user account on the live streaming interface based on the acquired screen ratio; and
display, in the determined display area, the live streaming picture of each of the first user account and the second user account based on the live streaming data streams.

In some embodiments, the displaying module is configured to:
display, in a case that a display area corresponding to the first user account is larger than a display area corresponding to the second user account, a live streaming picture of the first user account in the display area corresponding to the first user account based on a live streaming data stream of the first user account; and
display, based on a live streaming data stream of the second user account, a live streaming picture of the second user account in a first display area and the virtual resource in a second display area,
wherein the display area corresponding to the second user account includes the first display area and the second display area; and a difference between the interaction value of the first user account and the interaction value of the second user account is inversely proportional to a size of the first display area and directly proportional to a size of the second display area.

In some embodiments, the displaying module is configured to:
cancel, in response to the size of the first display area being smaller than a first threshold, the display of the live streaming picture of the second user account, and display, in a display form of not being covered by the virtual resource, identification information of the second user account in the display area corresponding to the second user account.

In some embodiments, the virtual resource is a virtual effect or a preset background image.

In some embodiments, the displaying module is configured to:
display, in a case that the display area corresponding to the first user account is larger than the display area corresponding to the second user account, the live streaming picture of the first user account in the display area corresponding to the first user account and the live streaming picture of the second user account in the display area corresponding to the second user account in a display form of covering the live streaming picture of the second user account with the live streaming picture of the first user account based on the live streaming data streams,
wherein a difference between an interaction value of the first user account and an interaction value of the second user account is directly proportional to a coverage range of the live streaming picture of the first user account over the live streaming picture of the second user account.

In some embodiments, the displaying module is configured to:
cancel, in response to the coverage range of the live streaming picture of the first user account over the live streaming picture of the second user account being greater than a second threshold, the display of the live streaming picture of the second user account, and display, in a display form of not being covered by the live streaming picture of the first user account, identification information of the second user account in the display area corresponding to the second user account.

In some embodiments, the displaying module is further configured to:
display, in response to receiving a feedback instruction, the live streaming picture of each of the first user account and the second user account on the live streaming interface in a screen ratio corresponding to the current split-screen mode based on the acquired live streaming data streams,
wherein the feedback instruction is generated based on a trigger operation by either the first user account or the second user account on a target control, the target control being configured to cancel a display of live streaming pictures according to screen ratios determined by interaction values.

In some embodiments, the second acquiring module is configured to:
acquire, in a case that a preset condition is met, the screen ratio corresponding to each of the first user account and the second user account,
wherein the preset condition includes at least one of:
a version number of the target application installed on a first terminal and a second terminal being greater than a preset version number, wherein the first terminal is a terminal corresponding to the first user account, and the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of the initiator in the interactive live streaming between the first user account and the second user account being greater than a threshold number; and
both the interaction value of the first user account and the interaction value of the second user account being greater than a score threshold.

In some embodiments, the second acquiring module is configured to:
acquire, in a case that a preset function from the target application is enabled, the screen ratio corresponding to each of the first user account and the second user account,
wherein the preset function is configured to enable displaying the live streaming pictures according to screen ratios determined by interaction values.

In some embodiments, the second acquiring module is configured to:
acquire a current interaction value of each of the first user account and the second user account;
acquire a screen ratio sent in a last time;
determine, based on the current interaction value of each of the first user account and the second user account, an initial screen ratio;
determine, in a case that the difference between the initial screen ratio and the screen ratio sent in the last time is greater than a set threshold, a new screen ratio according to the screen ratio sent in the last time and a preset variation step size; and determine the new screen ratio as a screen ratio to be sent currently.

In some embodiments, the second acquiring module is configured to:
determine, based on the current interaction value of each of the first user account and the second user account, a current interaction value ratio between the first user account and the second user account;
acquire a mapping relationship between an interaction value ratio and a screen ratio, wherein the mapping relationship includes a plurality of screen ratio levels; and
determine a screen ratio level corresponding to the current interaction value ratio based on the mapping relationship, and determine the initial screen ratio based on the screen ratio level.

In some embodiments, the displaying module is further configured to:
display, according to the interaction value of the first user account and interaction value of the second user account, a progress display control based on a size of the live streaming interface,
wherein a length of the progress display control is a same as a width or a height of the live streaming interface, and the progress display control displays a progress bar corresponding to each of the first user account and the second user account, a length of each progress bar being determined based on an interaction value of a corresponding user account.

In some embodiments, in response to a difference in the progress bar lengths between the first user account and the second user account falling within a first interval, a display area boundary between the first user account and the second user account aligns with a progress bar boundary.

In some embodiments, in response to the difference in the progress bar lengths between the first user account and the second user account falling within a second interval, a display area boundary between the first user account and the second user account is staggered with a progress bar boundary, wherein left boundary value of the second interval is smaller than left boundary value of a first interval, and right boundary value of the second interval is smaller than right boundary value of the first interval;
the difference in the progress bar lengths between the first user account and the second user account is directly proportional to a degree of staggering between the display area boundary and the progress bar boundary.

All of the aforementioned optional technical solutions can be combined in any way to form various optional embodiments of the present disclosure, which are not further repeated herein.

FIG. 18 is a block diagram showing another apparatus for displaying live streaming data according to some embodiments of the present disclosure. Referring to FIG. 18, the apparatus includes:
a first sending module 1801, configured to send, during an interactive live streaming, a live streaming data stream of at least one second user account participating in the interactive live streaming to a first terminal corresponding to a first user account;
a determining module 1802, configured to determine, according to an interaction value of each of the first user account and the second user account, a screen ratio corresponding to each of the first user account and the second user account; and
a second sending module 1803, configured to send the screen ratio corresponding to each of the first user account and the second user account to the first terminal,
wherein the first terminal is configured to display, based on the acquired screen ratio, the live streaming pictures of the first user account and the second user account on a live streaming interface of the first user account based on the live streaming data streams of the first user account and the second user account.

In the apparatus for displaying live streaming data according to the embodiments of the present disclosure, during an interactive live streaming with a plurality of user accounts, a dynamic screen ratio is acquired according to the interaction values between these user accounts, and the dynamic screen ratio is then used to render the live streaming picture on the terminal side. In other words, in the apparatus, the size of the display area for the live streaming picture is associated with the interaction value, which enriches the way of displaying the live streaming picture during the interactive live streaming and has a better display effect.

In some embodiments, the determining module is configured to:
acquire a current interaction value of each of the first user account and the second user account;
acquire a screen ratio sent in a last time corresponding to each of the first user account and the second user account; and
determine, based on the current interaction value of each of the first user account and the second user account and the screen ratio sent in the last time, the screen ratio to be sent currently; and
the second sending module is configured to determine, in response to a difference between the screen ratio to be sent currently and the screen ratio sent in the last time, the screen ratio to be sent currently as a new screen ratio corresponding to each of the first user account and the second user account and send the new screen ratio to the first terminal.

In some embodiments, the determining module is configured to:
determine, in response to meeting a preset condition, the screen ratio corresponding to each of the first user account and the second user account according to the interaction value of each of the first user account and the second user account,
wherein the preset condition includes at least one of:
a version number of a target application installed on a first terminal and a second terminal being greater than a preset version number, wherein the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of the initiator in the interactive live streaming between the first user account and the second user account being greater than a threshold number; and
both the interaction value of the first user account and the interaction value of the second user account being greater than a score threshold.

In some embodiments, the second sending module is configured to:
acquire a change event during the interactive live streaming, wherein the change event is configured to change a current live streaming picture layout;
acquire, in a case that there are a plurality of change events, a candidate change event by sorting the plurality of change events, and categorize by priority and filter the sorted change events; and
send, in response to a current pending candidate change event configured to indicate displaying the live streaming pictures according to the screen ratio, the screen ratio of each of the first user account and the second user account to the first terminal.

In some embodiments, the second sending module is configured to:
acquire the sorted change events by sorting the plurality of change events in chronological order; and
acquire the candidate change event by categorizing the sorted change events by priority according to business types thereof and filter out duplicate filterable change events,
wherein the filterable change events include events related to displaying the live streaming pictures according to the screen ratio.

In some embodiments, the determining module is further configured to:
acquire the number of likes and the number of virtual resources gifted by a third user account to the first user account;
acquire the number of likes and the number of virtual resources gifted by the third user account to the second user account;
determine, based on at least one of the number of likes and the number of virtual resources corresponding to the first user account, the interaction value of the first user account; and
determine, based on at least one of the number of likes and the number of virtual resources corresponding to the second user account, the interaction value of the first user account.

All of the aforementioned optional technical solutions can be combined in any way to form various optional embodiments of the present disclosure, which are not further repeated herein.

It should be noted that, in the case that the apparatus for displaying live streaming data according to the above embodiments displays the live streaming data, the division of the functional units is merely exemplary. In practice, the above functions can be assigned to different functional units as needed, that is, the internal structure of the apparatus for displaying live streaming data may be divided into different functional modules, to implement all or a part of the above functions. In addition, the apparatus for displaying live streaming data and the method for displaying live streaming data according to the above embodiments belong to the same concept, and specific implementation processes thereof are described in the method embodiments in detail, and are not further repeated herein.

With respect to the apparatus in the above embodiments, the specific manner in which each module operates has been described in detail in the embodiments related to the method, and will not be described in detail herein.

In some embodiments, an electronic device is further provided. The electronic device includes:
one or more processors; and
a memory configured to store one or more program codes executable by the one or more processors,
wherein the one or more processors, when loading and executing the one or more program codes, are caused to perform:

acquiring, during an interactive live streaming, live streaming data streams of a first user account and at least one second user account participating in the interactive live streaming;
acquiring a screen ratio corresponding to each of the first user account and the second user account, wherein the screen ratio corresponding to the first user account is determined according to an interaction value of the first user account and the screen ratio corresponding to the second user account is determined according to an interaction value of the second user account; and
displaying, based on the acquired screen ratio, live streaming pictures of the first user account and the second user account on a live streaming interface of the first user account based on the live streaming data streams.

In some embodiments, the one or more processors, when loading and executing the one or more program codes, are caused to perform:
determining, under a current split-screen mode, a display area corresponding to each of the first user account and the second user account on the live streaming interface based on the acquired screen ratio; and
displaying, in the determined display area, the live streaming picture of each of the first user account and the second user account based on the live streaming data streams.

In some embodiments, the one or more processors, when loading and executing the one or more program codes, are caused to perform:
displaying, in a case that a display area corresponding to the first user account is larger than the display area corresponding to the second user account, a live streaming picture of the first user account in the display area corresponding to the first user account based on a live streaming data stream of the first user account; and
displaying, based on a live streaming data stream of the second user account, a live streaming picture of the second user account in a first display area and a virtual resource in a second display area,
wherein the display area corresponding to the second user account includes the first display area and the second display area; and a difference between the interaction value of the first user account and the interaction value of the second user account is inversely proportional to a size of the first display area and directly proportional to a size of the second display area.

In some embodiments, the one or more processors, when loading and executing the one or more program codes, are caused to perform:
canceling, in response to the size of the first display area being smaller than a first threshold, a display of the live streaming picture of the second user account, and displaying, in a display form of not being covered by the virtual resource, identification information of the second user account in the display area corresponding to the second user account.

In some embodiments, the virtual resource is a virtual effect or a preset background image.

In some embodiments, the one or more processors, when loading and executing the one or more program codes, are caused to perform:
displaying, in a case that a display area corresponding to the first user account is larger than a display area corresponding to the second user account, a live streaming picture of the first user account in the display area corresponding to the first user account and a live streaming picture of the second user account in the display area corresponding to the second user account in a display form of covering the live streaming picture of the second user account with the live streaming picture of the first user account based on the live streaming data streams,
wherein a difference between an interaction value of the first user account and an interaction value of the second user account is directly proportional to the coverage range of the live streaming picture of the first user account over the live streaming picture of the second user account.

In some embodiments, the one or more processors, when loading and executing the one or more program codes, are caused to perform:
canceling, in response to the coverage range of the live streaming picture of the first user account over the live streaming picture of the second user account being greater than a second threshold, a display of the live streaming picture of the second user account, and displaying, in a display form of not being covered by the live streaming picture of the first user account, identification information of the second user account in the display area corresponding to the second user account.

In some embodiments, the one or more processors, when loading and executing the one or more program codes, are caused to perform:
displaying, in response to receiving a feedback instruction, the live streaming picture of each of the first user account and the second user account on the live streaming interface in a screen ratio corresponding to the current split-screen mode based on the acquired live streaming data streams,
wherein the feedback instruction is generated based on a trigger operation by either the first user account or the second user account on a target control, the target control being configured to cancel a display of live streaming pictures according to screen ratios determined by interaction values.

In some embodiments, the one or more processors, when loading and executing the one or more program codes, are caused to perform:
acquiring, in a case that a preset condition is met, the screen ratio corresponding to each of the first user account and the second user account,
wherein the preset condition includes at least one of:
a version number of the target application installed on a first terminal and a second terminal being greater than a preset version number, wherein the first terminal is a terminal corresponding to the first user account, and the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of an initiator in the interactive live streaming between the first user account and the second user account being greater than a threshold number; and
both the interaction value of the first user account and the interaction value of the second user account being greater than a score threshold.

In some embodiments, the one or more processors, when loading and executing the one or more program codes, are caused to perform:
acquiring, in a case that a preset function from the target application is enabled, the screen ratio corresponding to each of the first user account and the second user account,
wherein the preset function is configured to enable displaying the live streaming pictures according to screen ratios determined by interaction values.

In some embodiments, the one or more processors, when loading and executing the one or more program codes, are caused to perform:
acquiring a current interaction value of each of the first user account and the second user account;
acquiring a screen ratio sent in a last time; and
determining, based on the current interaction value of each of the first user account and the second user account, an initial screen ratio;
determining, in a case that a difference between the initial screen ratio and the screen ratio sent in the last time is greater than a set threshold, a new screen ratio according to the screen ratio sent in the last time and a preset variation step size; and
determining the new screen ratio as a screen ratio to be sent currently.

In some embodiments, the one or more processors, when loading and executing the one or more program codes, are caused to perform:
determining, based on the current interaction value of each of the first user account and the second user account, a current interaction value ratio between the first user account and the second user account;
acquiring a mapping relationship between an interaction value ratio and a screen ratio, wherein the mapping relationship includes a plurality of screen ratio levels;
determining a screen ratio level corresponding to the current interaction value ratio based on the mapping relationship; and
determining, based on the screen ratio level, the initial screen ratio.

In some embodiments, the one or more processors, when loading and executing the one or more program codes, are caused to perform:
displaying, according to the interaction value of the first user account and the interaction value of the second user account, a progress display control based on a size of the live streaming interface,
wherein a length of the progress display control is a same as a width or a height of the live streaming interface, and the progress display control displays the progress bar corresponding to each of the first user account and the second user account, a length of each progress bar being determined based on an interaction value of a corresponding user account.

In some embodiments, in response to a difference in the progress bar lengths between the first user account and the second user account falling within a first interval, a display area boundary between the first user account and the second user account aligns with a progress bar boundary.

In some embodiments, in response to the difference in the progress bar lengths between the first user account and the second user account falling within a second interval, the display area boundary between the first user account and the second user account is staggered with a progress bar boundary, wherein left boundary value of the second interval is smaller than left boundary value of a first interval, and right boundary value of the second interval is smaller than right boundary value of the first interval;
the difference in the progress bar lengths between the first user account and the second user account is directly proportional to the degree of staggering between the display area boundary and the progress bar boundary.

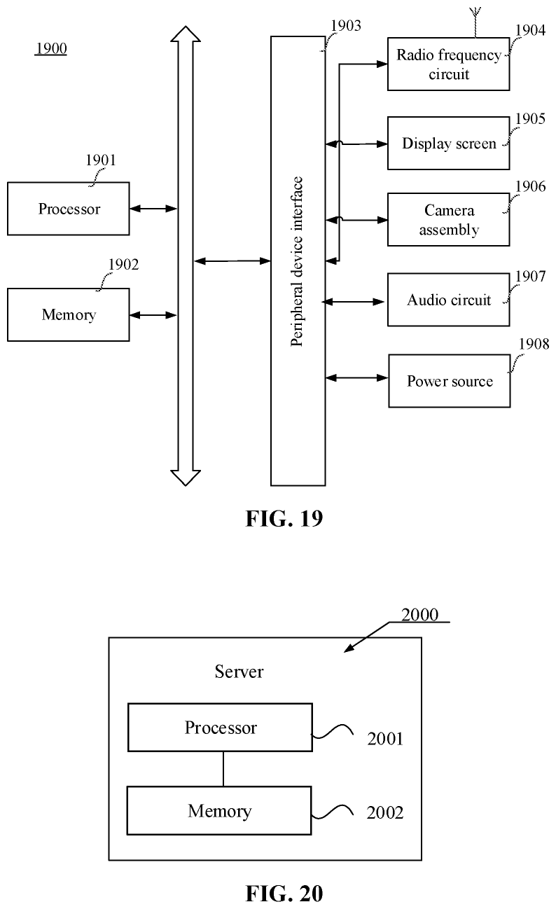

In response to the electronic device being provided as a terminal, FIG. 19 is a block diagram showing a terminal 1900 according to some embodiments of the present disclosure.

Generally, the terminal 1900 includes a processor 1901 and a memory 1902.

The processor 1901 includes one or more processing cores, such as a 4-core processor and an 8-core processor. The processor 1901 is implemented in at least one hardware form of a digital signal processor (DSP), a field programmable gate array (FPGA), and a programmable logic array (PLA). The processor 1901 also includes a main processor and a coprocessor. The main processor is a processor configured to process data in an awake state, and is also referred to as a central processing unit (CPU). The coprocessor is a low-power processor configured to process data in a standby state. In some embodiments, the processor 1901 is integrated with a graphics processing unit (GPU) that is responsible for rendering and drawing contents that need to be displayed on a display screen. In some other embodiments, the processor 1901 further includes an artificial intelligence (AI) processor for processing computing operations related to machine learning.

The memory 1902 includes one or more computer-readable storage media, which is non-transitory. The memory 1902 further includes a high-speed random access memory, and a non-volatile memory, such as one or more magnetic disk storage devices and flash storage devices. In some embodiments, a non-transitory computer-readable storage medium in the memory 1902 is configured to store at least one program code. The at least one program code is configured to be run by the processor 1901 to perform the method for displaying live streaming data in the method embodiments, where the terminal is responsible for execution.

In some embodiments, the terminal 1900 further includes a peripheral device interface 1903 and at least one peripheral device. The processor 1901, the memory 1902, and the peripheral device interface 1903 are connected via buses or signal lines. The peripheral devices are connected to the peripheral device interface 1903 via a bus, signal line, or circuit board. The peripheral devices include at least one of a radio frequency circuit 1904, a display screen 1905, a camera assembly 1906, an audio circuit 1907, and a power source 1908.

The peripheral device interface 1903 is configured to connect at least one peripheral device associated with an input/output (I/O) to the processor 1901 and the memory 1902. In some embodiments, the processor 1901, the memory 1902, and the peripheral device interface 1903 are integrated on the same chip or circuit board. In some other embodiments, any one or two of the processor 1901, the memory 1902, and the peripheral device interface 1903 are implemented on a separate chip or circuit board, which is not limited in the embodiments of the present disclosure.

The radio frequency circuit 1904 is configured to receive and transmit a radio frequency (RF) signal, which is also referred to as an electromagnetic signal. The radio frequency circuit 1904 is communicated with a communication network and other communication devices via electromagnetic signals. The radio frequency circuit 1904 converts an electrical signal into an electromagnetic signal for transmission or converts a received electromagnetic signal into an electrical signal. In some embodiments, the radio frequency circuit 1904 includes an antenna system, an RF transceiver, one or more amplifiers, a tuner, an oscillator, a digital signal processor, a codec chipset, a subscriber identity module card, and the like. The radio frequency circuit 1904 is communicated with other terminals via at least one wireless communication protocol. The wireless communication protocol includes, but is not limited to, a metropolitan area network, various generations of mobile communication networks (2G, 3G, 4G, and 5G), a wireless local area network, and/or a wireless fidelity (Wi-Fi) network. In some embodiments, the radio frequency circuit 1904 further includes a near field communication (NFC) related circuit, which is not limited in the embodiments of the present disclosure.

The display screen 1905 is configured to display a user interface (UI). The UI includes graphics, text, icons, videos, and any combination thereof. In the case that the display screen 1905 is a touch display screen, the display screen 1905 also has the capacity to acquire a touch signal on or above a surface of the display screen 1905. The touch signal is input to the processor 1901 as a control signal for processing. In this case, the display screen 1905 is also configured to provide virtual buttons and/or virtual keyboards, which are also referred to as soft buttons and/or soft keyboards. In some embodiments, there is one display screen 1905 arranged on a front panel of the terminal 1900; in some other embodiments, there are at least two display screens 1905 arranged on different surfaces of the terminal 1900, respectively or in a folded design. In some still other embodiments, the display screen 1905 is a flexible display screen arranged on a curved surface or a folded surface of the terminal 1900. Moreover, the display screen 1905 may have an irregular shape other than a rectangle, that is, an irregular-shaped screen. The display screen 1905 is prepared by using a material such as a liquid crystal display (LCD) or an organic light-emitting diode (OLED).

The camera assembly 1906 is configured to capture images or videos. In some embodiments, the camera component 1906 includes a front camera and a rear camera. Generally, the front camera is disposed on the front panel of the terminal and the rear camera is disposed on a back side of the terminal. In some embodiments, there are at least two rear cameras, and each of the at least two rear cameras is any one of a main camera, a depth-of-field camera, a wide-angle camera, and a telephoto camera, to realize a background blurring function realized by fusion of the main camera and the depth-of-field camera, panoramic shooting and virtual reality (VR) shooting functions by fusion of the main camera and the wide-angle camera, or other fusion shooting functions. In some embodiments, the camera component 1906 further includes a flash. The flash is a mono-color temperature flash or a two-color temperature flash. The two-color temperature flash is a combination of a warm-light flash and a cold-light flash, and can be used for light compensation at different color temperatures.

The audio circuit 1907 includes a microphone and a loudspeaker. The microphone is configured to acquire sound waves of the user and the environment, and convert the sound waves into electrical signals which are input into the processor 1901 for processing, or input into the radio frequency circuit 1904 for voice communication. For stereo collection or noise reduction, there are a plurality of microphones disposed at different parts of the terminal 1900, respectively. The microphone is also an array microphone or an omnidirectional acquisition microphone. The loudspeaker is configured to convert the electrical signal from the processor 1901 or the radio frequency circuit 1904 into sound waves. The loudspeaker is a conventional film loudspeaker and is also a piezoelectric ceramic loudspeaker. In the case that the loudspeaker is a piezoelectric ceramic loudspeaker, the electrical signals can be converted into not only human-audible sound waves but also the sound waves that are inaudible to humans for ranging and the like. In some embodiments, the audio-frequency circuit 1907 further includes a headphone jack.

The power source 1908 is configured to supply power for various components in the terminal 1900. The power source 1908 is an alternating current, a direct current, a disposable battery, or a rechargeable battery. In the case that the power source 1908 includes a rechargeable battery, the rechargeable battery is a wired charging battery or a wireless charging battery. The rechargeable battery also supports the fast charging technology.

Those skilled in the art can understand that the structure illustrated in FIG. 19 does not constitute a limitation of the terminal 1900, and may include more or fewer components than illustrated, or a combination of certain components, or a different arrangement of components.

In some embodiments, an electronic device is further provided. The electronic device includes:
one or more processors; and
a memory configured to store one or more program codes executable by the one or more processors,
wherein the one or more processors, when loading and executing the one or more program codes, are caused to perform:
sending, during an interactive live streaming, a live streaming data stream of at least one second user account participating in the interactive live streaming to a first terminal corresponding to a first user account;
determining, according to an interaction value of each of the first user account and the second user account, a screen ratio corresponding to each of the first user account and the second user account; and
sending the screen ratio corresponding to each of the first user account and the second user account to the first terminal,
wherein the first terminal is configured to display, based on the acquired screen ratio, live streaming pictures of the first user account and the second user account on a live streaming interface of the first user account based on the live streaming data streams of the first user account and the second user account.

In some embodiments, the one or more processors, when loading and executing the one or more program codes, are caused to perform:
acquiring a current interaction value of each of the first user account and the second user account;
acquiring a screen ratio sent in a last time; and
determining, based on the current interaction value of each of the first user account and the second user account and the screen ratio sent in the last time, the screen ratio to be sent currently; and
sending the screen ratio corresponding to each of the first user account and the second user account to the first terminal includes:
determining, in response to the difference between the screen ratio to be sent currently and the screen ratio sent in the last time, the screen ratio to be sent currently as a new screen ratio corresponding to each of the first user account and the second user account and sending the new screen ratio to the first terminal.

In some embodiments, the one or more processors, when loading and executing the one or more program codes, are caused to perform:
determining, in response to meeting a preset condition, the screen ratio corresponding to each of the first user account and the second user account according to the interaction value of each of the first user account and the second user account,
wherein the preset condition includes at least one of:
a version number of the target application installed on a first terminal and a second terminal being greater than a preset version number, wherein the second terminal is a terminal corresponding to the second user account;
a type of an the interactive live streaming between the first user account and the second user account being of a preset interactive live streaming type;
an initiation mode of the interactive live streaming between the first user account and the second user account being of a preset initiation mode;
a number of followers of an initiator in the interactive live streaming between the first user account and the second user account being greater than a threshold number; and
both the interaction value of the first user account and the interaction value of the second user account being greater than a score threshold.

In some embodiments, the one or more processors, when loading and executing the one or more program codes, are caused to perform:
acquiring a change event during the interactive live streaming, wherein the change event is configured to change a current live streaming picture layout;
acquiring, in a case that there are a plurality of change events, a candidate change event by sorting the plurality of change events, and categorizing by priority and filtering the sorted change events; and
sending, in response to the current pending candidate change event configured to indicate displaying live streaming pictures according to a screen ratio, the screen ratio of each of the first user account and the second user account to the first terminal.

In some embodiments, the one or more processors, when loading and executing the one or more program codes, are caused to perform:
acquiring the sorted change events by sorting the plurality of change events in chronological order; and
acquiring the candidate change event by categorizing the sorted change events by priority according to business types thereof and filtering out duplicate filterable change events,
wherein the filterable change events include events related to displaying the live streaming pictures according to a screen ratio.

In some embodiments, the one or more processors, when loading and executing the one or more program codes, are caused to perform:
acquiring the number of likes and the number of virtual resources gifted by a third user account to the first user account;
acquiring the number of likes and the number of virtual resources gifted by the third user account to the second user account;
determining, based on at least one of the number of likes and the number of virtual resources corresponding to the first user account, the interaction value of the first user account; and
determining, based on at least one of the number of likes and the number of virtual resources corresponding to the second user account, the interaction value of the first user account.

In response to the electronic device being provided as a server, FIG. 20 is a block diagram showing a server 2000 according to some embodiments of the present disclosure. The server 2000 varies greatly depending on configuration or performance and includes one or more central processing units (CPU) 2001 and one or more memories 2002. The one or more memories 2002 store at least one program code, and the at least one program code is loaded and executed by the one or more processors 2001 to perform the method for displaying live streaming data in the method embodiments, where the server is responsible for execution. In addition, the server 2000 further includes a wired or wireless network interface, a keyboard, an input/output interface, and other components to facilitate input and output. The server 2000 further includes other components for implementing functions of the device, which are not repeated herein.

In some other embodiments, a computer-readable storage medium including instructions is further provided, such as a memory 1902 including one or more instructions. The one or more instructions, when executed by the processor 1901 of the terminal 1900 or by the processor 2001 of the server 2000, are caused to perform the aforementioned method for displaying live streaming data. In some embodiments, the computer-readable storage medium is a ROM, a random access memory (RAM), a CD-ROM, a magnetic tape, a floppy disk, an optical data storage device, and the like.

In some other embodiments, a computer program product is further provided. The computer program product includes one or more computer programs. The one or more computer programs, when executed by the processor 1901 of the terminal 1900 or by the processor 2001 of the server 2000, are caused to perform the aforementioned method for displaying live streaming data.

Other embodiments of the present disclosure are apparent to those skilled in the art from consideration of the specification and practice of the present invention disclosed herein. The present disclosure is intended to cover any variations, uses, or adaptations of the present disclosure following the general principles of the present disclosure and including known common knowledge or customary technical means undisclosed in the art of the present disclosure. The specification and embodiments are provided for illustrative purposes only, and the true scope and spirit of the present disclosure are indicated by the following claims.

It should be understood that the present disclosure is not limited to the precise arrangements that have been described above and illustrated in the accompanying drawings, and that various modifications and changes can be made without departing from the scope thereof. The scope of the present disclosure is limited solely by the appended claims.

What is claimed is:

1. A method for displaying live streaming data, applicable to a terminal corresponding to a first user account, the method comprising:
acquiring, during an interactive live streaming, live streaming data streams of the first user account and at least one second user account, wherein the first user account and the second user account are participating in the interactive live streaming;
acquiring a screen ratio corresponding to each of the first user account and the second user account, wherein the screen ratio corresponding to the first user account is determined according to an interaction value of the first user account and the screen ratio corresponding to the second user account is determined according to an interaction value of the second user account, wherein the interaction value reflects intensity of interaction between the first user account and the second user account; and
displaying, based on the acquired screen ratio, live streaming pictures of the first user account and the second user account on a live streaming interface of the first user account based on the live streaming data streams.

2. The method for displaying live streaming data according to claim 1, wherein said displaying, based on the acquired screen ratio, the live streaming pictures of the first user account and the second user account on the live streaming interface of the first user account based on the live streaming data streams comprises:
determining, under a current split-screen mode, a display area corresponding to each of the first user account and the second user account on the live streaming interface based on the acquired screen ratio; and
displaying, in the determined display area, the live streaming picture of each of the first user account and the second user account based on the live streaming data streams of the first user account and the second user account.

3. The method for displaying live streaming data according to claim 2, wherein said displaying, in the determined display area, the live streaming picture of each of the first user account and the second user account based on the live streaming data streams comprises:
displaying, in a case that a display area corresponding to the first user account is larger than a display area corresponding to the second user account, a live streaming picture of the first user account in the display area corresponding to the first user account based on a live streaming data stream of the first user account; and
displaying, based on a live streaming data stream of the second user account, a live streaming picture of the second user account in a first display area and a virtual resource in a second display area,
wherein the display area corresponding to the second user account comprises the first display area and the second display area, and a difference between the interaction value of the first user account and the interaction value of the second user account is inversely proportional to a size of the first display area and directly proportional to a size of the second display area.

4. The method for displaying live streaming data according to claim 3, wherein during the interactive live streaming, the method further comprises:
canceling, in response to the size of the first display area being smaller than a first threshold, a display of the live streaming picture of the second user account, and displaying, in a display form of not being covered by the virtual resource, identification information of the second user account in the display area corresponding to the second user account.

5. The method for displaying live streaming data according to claim 2, wherein said displaying, in the determined display area, the live streaming picture of each of the first user account and the second user account based on the live streaming data streams comprises:
displaying, in a case that a display area corresponding to the first user account is larger than a display area corresponding to the second user account, a live streaming picture of the first user account in the display area corresponding to the first user account and a live streaming picture of the second user account in the display area corresponding to the second user account in a display form of covering, in a coverage range, the live streaming picture of the second user account with the live streaming picture of the first user account based on the live streaming data streams,
wherein a difference between an interaction value of the first user account and an interaction value of the second user account is directly proportional to the coverage range of the live streaming picture of the first user account over the live streaming picture of the second user account.

6. The method for displaying live streaming data according to claim 5, wherein during the interactive live streaming, the method further comprises:
canceling, in response to the coverage range of the live streaming picture of the first user account over the live streaming picture of the second user account being greater than a second threshold, a display of the live streaming picture of the second user account, and displaying, in a display form of not being covered by the live streaming picture of the first user account, identification information of the second user account in the display area corresponding to the second user account.

7. The method for displaying live streaming data according to claim 1, wherein during the interactive live streaming, the method further comprises:
displaying, in response to receiving a feedback instruction, the live streaming picture of each of the first user account and the second user account on the live streaming interface in a screen ratio corresponding to a current split-screen mode based on the acquired live streaming data streams,
wherein the feedback instruction is generated based on a trigger operation by either the first user account or the second user account on a target control, the target control being configured to cancel a display of live streaming pictures according to screen ratios determined by interaction values.

8. The method for displaying live streaming data according to claim 1, wherein said acquiring the screen ratio corresponding to each of the first user account and the second user account comprises:
acquiring, in a case that a preset condition is met, the screen ratio corresponding to each of the first user account and the second user account,
wherein the preset condition comprises at least one of:
a version number of a target application installed on a first terminal and a second terminal being greater than a preset version number, wherein the first terminal is a terminal corresponding to the first user account, and the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of an initiator in the interactive live streaming between the first user account and the second user account being greater than a threshold number; and
both the interaction value of the first user account and the interaction value of the second user account being greater than a score threshold.

9. The method for displaying live streaming data according to claim 1, wherein said acquiring the screen ratio corresponding to each of the first user account and the second user account comprises:
acquiring, in a case that a preset function from a target application is enabled, the screen ratio corresponding to each of the first user account and the second user account,
wherein the preset function is configured to enable displaying live streaming pictures according to screen ratios determined by interaction values.

10. The method for displaying live streaming data according to claim 1, wherein said acquiring the screen ratio of each of the first user account and the second user account comprises:
acquiring a current interaction value of each of the first user account and the second user account;
acquiring a screen ratio sent in a last time;
determining, based on the current interaction value of each of the first user account and the second user account, an initial screen ratio;
determining, in a case that a difference between the initial screen ratio and the screen ratio sent in the last time is not greater than a set threshold, the initial screen ratio as a screen ratio to be sent currently; and
determining, in a case that a difference between the initial screen ratio and the screen ratio sent in the last time is greater than a set threshold, a new screen ratio according to the screen ratio sent in the last time and a preset variation step size; and determining the new screen ratio as a screen ratio to be sent currently.

11. The method for displaying live streaming data according to claim 10, wherein said determining, based on the current interaction value of each of the first user account and the second user account, the initial screen ratio comprises:
determining, based on the current interaction value of each of the first user account and the second user account, a current interaction value ratio between the first user account and the second user account;
acquiring a mapping relationship between an interaction value ratio and a screen ratio, wherein the mapping relationship comprises a plurality of screen ratio levels;
determining a screen ratio level corresponding to the current interaction value ratio based on the mapping relationship; and
determining, based on the screen ratio level, the initial screen ratio.

12. The method for displaying live streaming data according to claim 1, wherein during the interactive live streaming, the method further comprises:
displaying, according to the interaction value of the first user account and the interaction value of the second user account, a progress display control based on a size of the live streaming interface,
wherein a length of the progress display control is a same as a width or a height of the live streaming interface, and the progress display control displays a progress bar corresponding to each of the first user account and the second user account, a length of each progress bar being determined based on an interaction value of a corresponding user account.

13. The method for displaying live streaming data according to claim 12, wherein in response to a difference in the progress bar lengths between the first user account and the second user account falling within a first interval, a display area boundary between the first user account and the second user account aligns with a progress bar boundary between the first user account and the second user account.

14. The method for displaying live streaming data according to claim 13, wherein in response to a difference in the progress bar lengths between the first user account and the second user account falling within a second interval, a display area boundary between the first user account and the second user account is staggered with a progress bar boundary between the first user account and the second user account, wherein the second interval is greater than the first interval;
the difference in the progress bar lengths between the first user account and the second user account is directly proportional to a degree of staggering between the display area boundary and the progress bar boundary.

15. A method for displaying live streaming data, applicable to a server, the method comprises:
sending, during an interactive live streaming, a live streaming data stream of at least one second user account participating in the interactive live streaming to a first terminal corresponding to a first user account, wherein the first user account is participating the interactive live streaming;
determining, according to an interaction value of each of the first user account and the second user account, a screen ratio corresponding to each of the first user account and the second user account; and
sending the screen ratio corresponding to each of the first user account and the second user account to the first terminal,
wherein the first terminal is configured to display, based on the determined screen ratio, live streaming pictures of the first user account and the second user account on a live streaming interface of the first user account based on live streaming data streams of the first user account and the second user account.

16. The method for displaying live streaming data according to claim 15, wherein said determining, according to the interaction value of each of the first user account and the second user account, the screen ratio corresponding to each of the first user account and the second user account comprises:
acquiring a current interaction value of each of the first user account and the second user account;
acquiring a screen ratio sent in a last time; and
determining, based on the current interaction value of each of the first user account and the second user account and the screen ratio sent in the last time, a screen ratio to be sent currently; and
said sending the screen ratio corresponding to each of the first user account and the second user account to the first terminal comprises:
determining, in response to a difference between the screen ratio to be sent currently and the screen ratio sent in the last time, the screen ratio to be sent currently as a new screen ratio corresponding to each of the first user account and the second user account and sending the new screen ratio to the first terminal.

17. The method for displaying live streaming data according to claim 15, wherein said determining, according to the interaction value of each of the first user account and the second user account, the screen ratio corresponding to each of the first user account and the second user account comprises:
determining, in response to meeting a preset condition, the screen ratio corresponding to each of the first user account and the second user account according to the interaction value of each of the first user account and the second user account,
wherein the preset condition comprises at least one of:
a version number of a target application installed on the first terminal and a second terminal being greater than a preset version number, wherein the second terminal is a terminal corresponding to the second user account;
a type of an interactive live streaming between the first user account and the second user account being of a preset interactive live streaming type;
an initiation mode of the interactive live streaming between the first user account and the second user account being of a preset initiation mode;
a number of followers of an initiator in the interactive live streaming between the first user account and the second user account being greater than a threshold number; and
both the interaction value of the first user account and the interaction value of the second user account being greater than a score threshold.

18. The method for displaying live streaming data according to claim 15, wherein said sending the screen ratio corresponding to each of the first user account and the second user account to the first terminal comprises:
acquiring a change event during the interactive live streaming, wherein the change event is configured to change a current live streaming picture layout;
acquiring, in a case that there are a plurality of change events, a candidate change event by sorting the plurality of change events, and categorizing by priority and filtering the sorted change events; and
sending, in response to a current pending candidate change event configured to indicate displaying live streaming pictures according to a screen ratio, the screen ratio of each of the first user account and the second user account to the first terminal.

19. The method for displaying live streaming data according to claim 18, wherein said acquiring the candidate change event by sorting the plurality of change events, and categorizing by priority and filtering the sorted change events comprises:
acquiring the sorted change events by sorting the plurality of change events in chronological order; and
acquiring the candidate change event by categorizing the sorted change events by priority according to business types thereof, and filtering out duplicate filterable change events,
wherein the filterable change events comprise events related to displaying live streaming pictures according to a screen ratio.

20. An electronic device, comprising:
one or more processors; and
a memory configured to store one or more program codes executable by the one or more processors,
wherein the one or more processors, when loading and executing the one or more program codes, are caused to perform:
acquiring, during an interactive live streaming, live streaming data streams of a first user account and at least one second user account participating in the interactive live streaming;
acquiring a screen ratio corresponding to each of the first user account and the second user account, wherein the screen ratio corresponding to the first user account is determined according to an interaction value of the first user account and the screen ratio corresponding to the second user account is determined according to an interaction value of the second user account; and
displaying, based on the acquired screen ratio, live streaming pictures of the first user account and the second user account on a live streaming interface of the first user account based on the live streaming data streams.
